(19) United States
(12) Patent Application Publication
(10) Pub. No.: US 2020/0073268 A1
(43) Pub. Date: Mar. 5, 2020

(54) IMAGE FORMING METHOD AND PRINTED IMAGE

(71) Applicant: Konica Minolta, Inc., Tokyo (JP)

(72) Inventors: Haruo Horiguchi, Tokyo (JP); Michiyo Fujita, Tokyo (JP); Makoto Nomiya, Tokyo (JP); Seijiro Takahashi, Tokyo (JP)

(21) Appl. No.: 16/448,504

(22) Filed: Jun. 21, 2019

(30) Foreign Application Priority Data
Aug. 28, 2018 (JP) 2018-158850

(51) Int. Cl. G03G 9/097

(52) U.S. Cl. CPC G03G 9/09775; G03G 9/09758

(57) ABSTRACT

Provided is an image forming method for forming an image including a recording medium and a layer containing a photosoftening compound disposed thereon, the image forming method containing the steps of: supplying a powder for adhering the powder to the image; and irradiating the image with light to melt or to soften the image.

Japanese Patent Application No. 2018-158850, filed on Aug. 28, 2018 with Japan Patent Office, is incorporated herein by reference in its entirety.

### BACKGROUND

### 1. Technological Field

The present invention relates to an image forming method and a printed image. More specifically, the present invention relates to an image forming method for forming an image having a decorative expression on a necessary portion not only for paper media but also for recording media with low heat resistance such as plastic films. In particular, the present invention relates to an image forming method that enables to reproduce images of mirror tone-pearl tone, and glitter tone by using the same powder.

### 2. Description of the Related Art

In recent years, in the on-demand printing market, the demand for feature printing and high value-added printing is increasing. Above all, requests for metallic printing and pearl printing are particularly large, and various studies have been conducted. Here, metallic printing refers to printing of an image having metallic gloss, and pearl printing refers to printing of an image having pearlescent gloss.

As one of the methods, a method of transferring a metal foil or a resin foil using a toner as an adhesive layer has been considered. For example, Patent Document 1 (JP-A 01-200985) proposes a method of forming a toner image and adhering a transfer foil only to the toner portion. In this method, when the foil is transferred to only a part of the image, there is a problem that all the remaining foil is wasted. In addition, when printing a plurality of metallic expressions such as mirror tone and glitter tone, it was necessary to prepare different foils respectively.

On the other hand, studies have also been made to add a bright pigment to a toner. For example, in Patent Document 2 (JP-A 2014-157249), there is proposed a method of forming a metallic image only on a necessary portion by containing a bright pigment in a toner. However, this method has not reached the required metallic and pearly feeling.

As another method, for example, Patent Document 3 (JP-A 2013-178452) proposes that a metallic powder is formed by adhering a paint powder to a toner image. However, in this method, it has been difficult to achieve a plurality of decorative expressions with the same powder. That is, in order to form a glossy image having a plurality of different textures, it was necessary to use different types of paint powders. Therefore, with the technique of Patent Document 3, it is difficult to achieve a plurality of decorative expressions having different textures with the same paint powder in forming a glossy image.

### SUMMARY

The present invention has been made in view of the above problems and circumstances. An object of the present invention is to provide an image forming method for forming an image having a decorative expression on a necessary portion not only for paper media but also for recording media with low heat resistance such as plastic films, and to provide a printed image. In particular, an object of the present invention is to provide an image forming method that enables to reproduce images of mirror tone-pearl tone, and glitter tone by using the same powder.

An image forming method reflecting an aspect of the present invention to achieve the above-describe object is an image forming method for forming an image comprising a recording medium and a layer containing a photosoftening compound disposed thereon, the image forming method comprising the steps of:

supplying a powder for adhering the powder to the image; and

irradiating the image with light to melt or to soften the image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a schematic diagram for explaining an image forming method according to an embodiment of the present invention.

FIG. 2 is a schematic diagram for explaining an image forming method according to another embodiment of the present invention.

FIG. 3 is a schematic diagram for explaining an image forming method according to another embodiment of the present invention.

FIG. 4 is a schematic diagram for explaining an image forming method according to an example of a comparative example.

### DETAILED DESCRIPTION OF THE EMBODIMENTS

Hereinafter, one or more embodiments of the present invention will be described with reference to the drawings. However, the scope of the invention is not limited to the disclosed embodiments.

The image forming method of the present invention is an image forming method for forming an image comprising a recording medium and a layer containing a photosoftening compound disposed thereon. It has a powder supply step for adhering powder to the image, and a light irradiation step for melting or softening the image. This feature is a technical feature common or corresponding to the following embodiments. By the above-described embodiments of the present invention, it is possible to provide an image forming method that enables to form an image having a decorative expression on a necessary portion not only for a paper medium but also for a recording medium with low heat resistance such as a plastic film, and it is possible to provide a printed image. In particular, it is possible to provide an image forming method that enables to reproduce images of mirror tone-pearl tone and glitter tone by using the same powder. The expression mechanism or the action mechanism of effects of the present invention is not clear, but it is presumed as follows.

The photosoftening compound in the present invention is a compound that melts or softens by changing the molecular structure by light absorption, and thus does not require a special heating step when melting or softening. Therefore, by incorporating these photosoftening compounds in the toner, it becomes possible to adhere the supplied powder that exhibits various glosses by light irradiation without heating the toner image to a high temperature. That is, in addition to the partial decorative expression by light irradiation, it is assumed that it also becomes possible to decorate a recording medium (such as a film) having low thermal resistance and to decorate a powder (such as thermally expanded microcapsules) having low thermal resistance.

Further, in the image forming method of the present invention, the image is melted or softened by irradiating light to the photosoftening compound-containing layer (that is, the image) that melts or softens by light absorption. At this time, the orientation of the powder adhered to the image changes depending on the state (softness) of the image surface. Therefore, in the present invention, the orientation of the powder may be controlled by controlling the state of the image surface depending on the light irradiation amount (light amount), and various changes in the texture of the powder, particularly the reflection characteristics may be obtained. Therefore, by controlling the irradiation amount of light and the irradiation range, it is possible to form an image having the glossiness of different texture with the same powder.

Moreover, since the texture and decoration range of decoration can be controlled by light irradiation, it is not necessary to change the foil or the toner in order to impart a gloss of different texture as in the techniques of Patent Document 1 and Patent Document 2, for example. Therefore, according to the present invention, it is possible to form an image having a glossiness of different texture by a simple method, and to simplify the configuration and control of the image forming apparatus.

Further, in the image forming method of the present invention, since the state of the image surface is controlled by light irradiation, it is possible to finely divide the decorated part (the part to which the powder adheres) and the non-decorated part (the part to which the powder does not adhere). In addition, since it is also possible to change the state of the image surface finely and continuously on one image, it also has the advantage of being able to form an image with better expressive power.

In one embodiment of the present invention, from the viewpoint of the effect of the preset invention, it is preferable that the photosoftening compound is a photoisomerization compound or a compound having a bond that is cleaved by light absorption. The photosoftening compound is melted or softened by changing the molecular structure by light absorption. Since the photosoftening compound melts or softens due to the molecular structure change associated with light absorption, it does not require a heating step when it is melted or softened, further, since the compound itself does not generate significant heat, it is preferable from the viewpoint of allowing the decoration of a low heat resistant recording medium and a powder with low heat resistance.

It is preferable that the image formed of the layer containing the photosoftening compound is an image fixed in advance. It is also preferable that the image forming method further contains the step of rubbing the image after the step of irradiating the image with light to melt or to soften the image. It is also preferable that the image forming method further contains the step of fixing the image in a melted state after the step of irradiating the image with light to melt or to soften the image. These embodiments are preferable from the viewpoint of selectively irradiating light to an image portion to be decorated in advance and further making the image into a melted state so that the supplied powder exhibiting metallic gloss may easily adheres. Further, it is preferable that the image supplied with the powder is rubbed, and if necessary, fixed by light irradiation from the viewpoint of uniformly expressing the desired decorative expression and metallic gloss on the image.

It is preferable that the powder is a powder of non-spherical particles, in particular, a powder of flat particles, and the thickness of the powder is in the range of 0.2 to 3.0 μm. These are preferable embodiments from the viewpoint of expressing a desired metallic gloss in the image according to the light irradiation amount.

In addition, it is preferable that the powder is a metal powder or a metal oxide powder, or a thermally responsive material, from the viewpoint of expressing a desired metallic gloss or a decorative expression (for example, embossing) on the image.

In addition, from the viewpoint that the image forming method of the present invention may be extended to recording medium having low heat resistance, it is preferable that the recording medium is a resin film.

In the light irradiation step, it is preferable to control the light amount. By controlling the amount of light, the state of the image surface may be controlled to control the orientation of the powder, and various reflection characteristics of the powder may be changed. Therefore, by controlling the irradiation amount of light and the irradiation range, it is possible to form an image having the glossiness of different texture with the same powder.

Further, by irradiating different portions of the recording medium with different light amounts, it is possible to produce a plurality of portions with different adhesion states of powder on one recording medium, and it is possible to obtain an image having a different texture on one recording medium.

The printed image of the present invention is a printed image having an image composed of a recording medium and a layer containing at least a photosoftening compound disposed thereon. A powder further adheres to the image, and the obtained image is a printed image in which an image of mirror tone-pearl tone, glitter tone, or a halftone thereof is reproduced.

The present invention and the constitution elements thereof, as well as configurations and embodiments, will be detailed in the following. In the present description, when two figures are used to indicate a range of value before and after “to”, these figures are included in the range as a lowest limit value and an upper limit value.

### «Outline of the Image Forming Method of the Present Invention»

The image forming method of the present invention is an image forming method for forming an image comprising a recording medium and a layer containing a photosoftening compound disposed thereon. It has a powder supply step for adhering powder to the image, and a light irradiation step for melting or softening the image.

The photosoftening compound in the present invention refers to a compound which melts or softens by changing the molecular structure by light absorption. The photosoftening compound may be either a low molecular weight compound or a polymer compound, and returns to its original state (or a state close to the original state) upon termination of light absorption or external stimulation. Although there are few reports on such photosoftening compounds, but, for example, an azobenzene derivative which is a photoisomerization compound, an azobenzene-containing polymer compound and a stilbene derivative, and a polymer having a branched chain of hexaarylimidazole group which cleaves a crosslinked structure by light absorption have been reported.

Since these photosoftening compounds melt or soften due to the molecular structure change accompanying light absorption, no special heating step is required when melting or softening. Therefore, for example, by incorporating these photosoftening compounds in the toner, it is possible to melt the toner image by light irradiation without being heated to a high temperature, and the supplied powder exhibiting the metallic gloss adheres to the melted image. That is, in addition to the partial decorative expression by light irradiation, it also becomes possible to decorate a recording medium (such as a film) having low thermal resistance and to decorate a powder (such as thermally expanded microcapsules) having low thermal resistance. In the present invention, “melting or softening” indicates as follows. “Melting” refers to a state in which the system is deformed without external force, and “softening” refers to a state in which the temperature of the system is higher than the glass transition temperature (Tg), that is, a state in which the system is deformed by an external force.

The image according to the present invention may be formed by a known image forming method such as dry and wet electrophotography and ink-jet method. Among them, the image is preferably formed by electrophotography.

Hereinafter, the configuration of the image forming method of the present invention will be described.

The image forming method of the present invention is an image forming method for forming an image comprising a recording medium and a layer containing a photosoftening compound disposed thereon. It has a powder supply step for adhering powder to the image, and a light irradiation step for melting or softening the image. Hereinafter, a “layer containing a photosoftening compound” is also referred to as a “photosoftening compound-containing layer”.

### (1) Recording Medium

In the image forming method of the present invention, the image according to the present invention is composed of a recording medium and a layer containing a photosoftening compound disposed thereon.

The recording medium is not particularly limited. Examples thereof include: plains papers from thin paper to thick paper, high quality paper, coated printing paper such as art paper or coated paper, Japanese paper or postcard paper commercially available; resin films such as polypropylene (PP) film, polyethylene terephthalate (PET) film, and triacetyl cellulose (TAC) film; and cloths. The present invention is not limited to them. Further, the color of the recording medium is not particularly limited, and various color recording media can be used.

On the other hand, the recording medium is preferably one having resistance (i.e., light resistance) to light irradiated in the light irradiation step. The term “light resistance” means that the change in the surface state of the recording medium, the chemical change, and the physical change are small before and after irradiation with light, particularly with ultraviolet light.

### (2) Photosoftening Compound

Preferable photosoftening compounds according to the present invention are: an azobenzene derivative which is a photoisomerization compound, an azobenzene-containing polymer compound and a stilbene derivative, and a polymer compound having a branched chain of hexaarylimidazole group which cleaves a crosslinked structure by light absorption. Among them, the azobenzene derivative, the azobenzene-containing polymer compound, and the polymer compound having a branched chain of hexaarylimidazole group are preferable.

### (2.1) Azobenzene Derivative

The photosoftening compound according to the present invention preferably contains an azobenzene derivative represented by the following Formula (1) (hereinafter, also referred to as an azobenzene derivative 1 in the present invention).

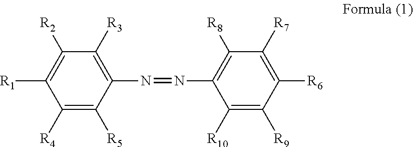

In Formula (1), R₁ to R₁₀ each independently represent a group selected from the group consisting of a hydrogen atom, an alkyl group, an alkoxy group, a halogen atom, a hydroxy group and a carboxy group. At least three of R₁ to R₁₀ represent a group selected from the group consisting of an alkyl group, an alkoxy group, a halogen atom, a hydroxy group and a carboxy group. At least one of R₁ to R₅ represents an alkyl group or an alkoxy group having 1 to 18 carbon atoms. And at least one of R₆ to R₁₀ represents an alkyl group or an alkoxy group having 1 to 18 carbon atoms.

The photosoftening compound containing the azobenzene derivative having the above-mentioned structure is improved in the melting or softening rate by light irradiation, and is excellent in the fixability of the image.

Azobenzene compounds are known to be materials that absorb light and melt or soften (light phase transition) from the solid state. The light phase transition of the azobenzene compound is considered to be caused by breakdown of the crystal structure by cis-trans isomerization. Since the azobenzene compound generally has strong intermolecular π-π interaction, light phase transition occurs only at the outermost surface of the crystal structure. On the other hand, in the azobenzene derivative which is a photosoftening compound according to the present invention, two benzene rings are each independently substituted with an alkyl group or an alkoxy group. Since the alkyl group and the alkoxy group have thermal mobility, the azobenzene derivative according to the present invention has a specific crystal structure in which isotropically disordered structures coexist due to thermal motion of an alkyl group or alkoxy group in a periodic structure in which the π-π interaction of the azobenzene moiety is dominant Therefore, when the cis-trans isomerization reaction proceeds locally and the π-π interaction of the azobenzene moiety is reduced, chain-wise isotropic melting or softening occurs throughout the system. In addition, the azobenzene derivative according to the present invention has a structure in which at least three hydrogen atoms of azobenzene are substituted with a group selected from the group consisting of an alkyl group, an alkoxy group, a halogen group, a hydroxy group and a carboxy group. With such a structure, the generation of lattice defects that favor cis-trans isomerization, the appearance of free volume, and the reduction of π-π interaction occur. Thus, cis-trans isomerization is more likely to proceed, and the compound melts or softens at a fast rate. Therefore, the photosoftening compound according to the present invention improves the melting or softening rate by light irradiation, and may improve the fixability of the image with less energy.

In Formula (1), R₁ to R₁₀ each independently represent a group selected from the group consisting of a hydrogen atom, an alkyl group, an alkoxy group, a halogen atom, a hydroxy group and a carboxy group. At least three of R₁ to R₁₀ represent a group selected from the group consisting of an alkyl group, an alkoxy group, a halogen atom, a hydroxy group and a carboxy group. At least one of R₁ to R₅ represents an alkyl group or an alkoxy group having 1 to 18 carbon atoms. And at least one of R₆ to R₁₀ represents an alkyl group or an alkoxy group having 1 to 18 carbon atoms. Examples of the alkyl group include: straight-chain alkyl groups such as a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group; and branched alkyl groups such as an isopropyl group, an isobutyl group, a sec-butyl group, a tert-butyl group, an isoamyl group, a tert-pentyl group, a neopentyl group, a 1-methylpentyl group, a 4-methyl-2-pentyl group, a 3,3-dimethylbutyl group, a 2-ethylbutyl group, a 1-methylhexyl group, a tert-octyl group, a 1-methylheptyl group, a 2-ethylhexyl group, a 2-propylpentyl group, a 2,2-dimethylheptyl group, a 2,6-dimethyl-4-heptyl group, a 3,5,5-trimethylhexyl group, a 1-methyldecyl group, and a 1-hexylheptyl group.

Examples of the alkoxy group include: straight-chain alkoxy groups such as a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, and an n-hexadecyloxy group; and branched alkoxy groups such as an isopropoxy group, a tert-butoxy group, a 1-methylpentyloxy group, a 4-methyl-2-pentyloxy group, a 3,3-dimethylbutyloxy group, a 2-ethylbutyloxy group, a 1-methylhexyloxy group, a tert-octyloxy group, a 1-methylheptyloxy group, a 2-ethylhexyloxy group, a 2-propylpentyloxy group, a 2,2-dimethylheptyloxy group, a 2,6-dimethyl-4-heptyloxy group, a 3,5,5-trimethylhexyloxy group, a 1-methyldecyloxy group, and a 1-hexylheptyloxy group.

The halogen atom refers to a fluorine atom (—F), a chlorine atom (—Cl), a bromine atom (—Br) or an iodine atom (—I).

In Formula (1), R₁ and R₆ are preferably each independently an alkyl group or an alkoxy group having 1 to 18 carbon atoms. Among them, from the viewpoint of further improving the fixability of the image, R₁ and R₆ are preferably each independently an alkoxy group having 1 to 18 carbon atoms. Thus, having an alkyl group or alkoxy group having 1 to 18 carbon atoms at the para position of two benzene rings increases the thermal mobility of the molecule. And as described above, it is likely that the overall melting or softening will occur in sequence throughout the system.

Although an alkyl group or an alkoxy group having 1 to 18 carbon atoms represented by R₁ and R₆ may be straight-chain or branched, from the viewpoint of forming the structure of rod-like molecules in which light phase transition is likely to occur, the straight-chain is preferable.

In particular, R₁ and R₆ are preferably each independently an alkyl group or an alkoxy group having 6 to 12 carbon atoms. When R₁ and R₆ are an alkyl group or an alkoxy group within the above-mentioned carbon number range, the alkyl-alkyl interaction acting between molecules is relatively weak while having high thermal mobility. Therefore, cis-trans isomerization is more likely to proceed, and the melting or softening rate by light irradiation and the fixation of the image are further improved.

R₁ and R₆ may be the same or different, but are preferably the same in terms of easiness of synthesis.

In Formula (1), at least one of R₂ to R₅ and R₇ to R₁₀ is a group selected from the group consisting of an alkyl group, an alkoxy group, a halogen group, a hydroxy group and a carboxy group (hereinafter referred to simply as “a substituent”). Having such a structure results in the formation of lattice defects that favor cis-trans isomerization, the appearance of free volume, and the reduction of π-π interactions. Therefore, cis-trans isomerization is more likely to proceed, and the melting or softening rate by light irradiation and the fixation of the image are further improved. In particular, from the viewpoint of securing a free volume necessary for cis-trans isomerization, at least one of R₂ to R₅ and R₇ to R₁₀ is preferably an alkyl or alkoxy group having 1 to 4 carbon atoms which may have a branch or a halogen group. From the viewpoint of further improving the fixability of the image, an alkyl group having 1 to 4 carbon atoms is more preferable, and a methyl group is particularly preferable. In Formula (1), the number of substituents in R₂ to R₅ and R₇ to R₁₀ is preferably 1 to 8, and more preferably 1 to 6. In particular, from the viewpoint of not lowering the melting point of the azobenzene derivative too much and further improving the heat resistant storage stability of the toner, the number of substituents is more preferably 1 to 4, and particularly preferably 1 to 3.

The position at which a substituent is present in R2 to R5 and R7 to R10 is not particularly limited, preferably, at least a substituent is present in any of R₂, R₄, R₇ and R₉ (in other words, the ortho position of R₁ and the ortho position of R₆) of Formula (1). Further preferably, a methyl group is present in any one of R₂, R₄, R₇ and R₉ of Formula (1). The azobenzene derivative having such a structure further improves the fixing property of the image since the melting or softening rate by light irradiation is further improved, and the melting point is appropriately increased, so that the heat resistant storage stability of the toner is also improved.

Preferable azobenzene derivatives according to the present invention are compounds derived from 4,4′-dialkyl azobenzene and 4,4′-bis(alkoxy) azobenzene. Examples thereof are derivatives of 4,4′-dialkyl azobenzene having the same alkyl group of 1 to 18 carbon atoms as R₁ and R₆ in Formula (1) such as 4,4′-dihexylazobenzene, 4,4′-dioctylazobenzene, 4,4′-didecylazobenzene, 4,4′-didodecylazobenzene, and 4,4′-dihexadecylazobenzene. Another examples thereof are derivatives of 4,4′-bis(alkoxy)azobenzene having the same alkoxy group of 1 to 18 carbon atoms as R₁ and R₆ in Formula (1) such as 4,4′-bis(hexyloxy)azobenzene, 4,4′-bis(octyloxy)azobenzene, 4,4′-bis(dodecyloxy)azobenzene, and 4,4′-bis(hexadecyloxy) azobenzene. Preferable derivatives are compounds in which the hydrogen atom attached to the benzene ring is mono-, di- or tri-substituted by a group selected from the group consisting of alkyl group, alkoxy group, halogen group, hydroxy group and carboxy group. More specifically, azobenzene derivatives (1) to (12) exemplified below may be mentioned.

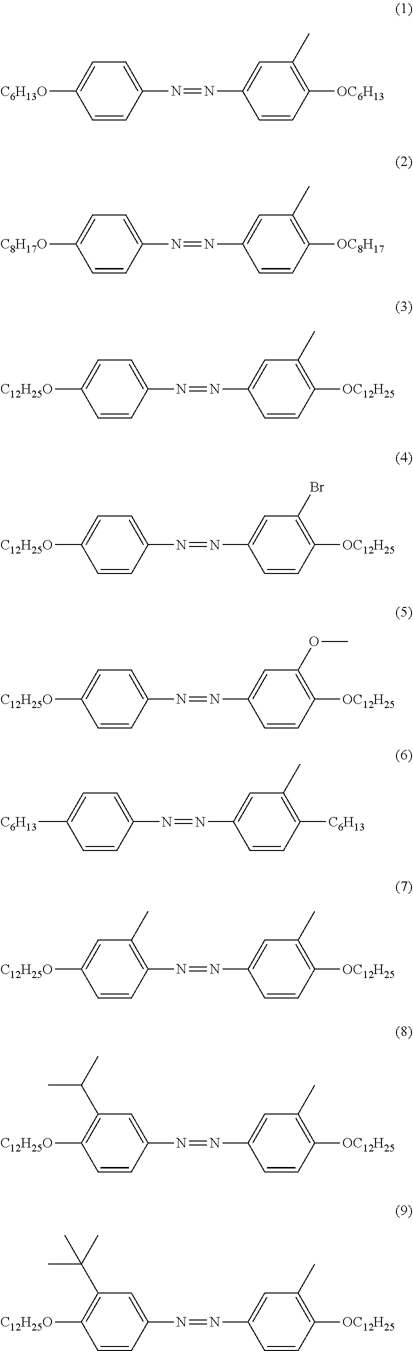

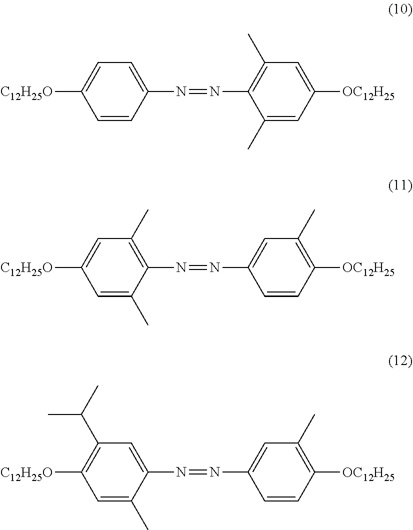

The synthetic method of the azobenzene derivative is not particularly limited, and conventionally known synthetic methods may be applied. For example, as in the following reaction scheme A, 4-aminophenol is reacted with sodium nitrite under cooling to form a diazonium salt. This is reacted with o-cresol to synthesize intermediate A (first step), and then n-bromohexane is allowed to react with the intermediate A. Thus, the above azobenzene derivative (1) may be obtained.

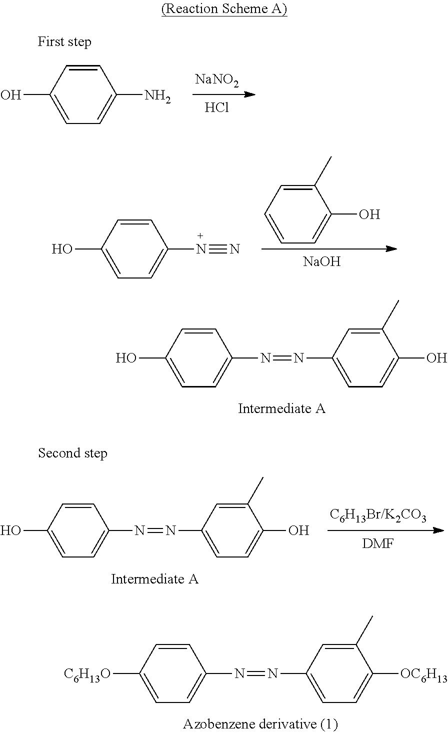

It is possible to obtain an azobenzene derivative in which R₁ and R₆ in Formula (1) are an alkoxy group by changing the raw materials (4-aminophenol, o-cresol and/or n-bromohexane) used in the above reaction scheme A to other compounds. Those skilled in the art may appropriately make the above changes to synthesize a desired azobenzene derivative. Moreover, when the above-described production method is used, the azobenzene derivative which has an asymmetrical structure may be obtained easily. For example, as shown in the following reaction scheme B, the azobenzene derivative (4) may be obtained by changing o-cresol and n-bromohexane to 2-bromophenol and n-bromododecane respectively.

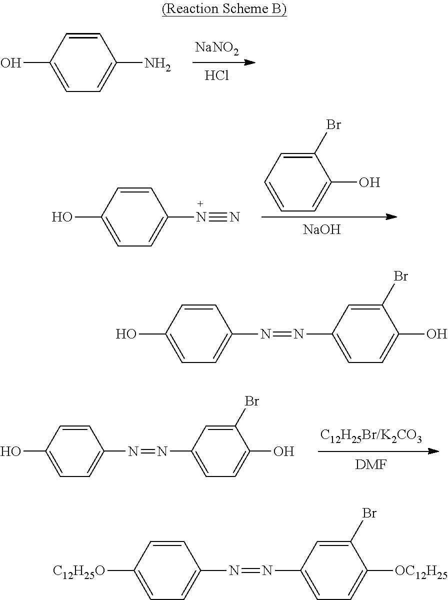

Alternatively, for example, as shown in the following reaction scheme C, manganese dioxide as an oxidizing agent is reacted with p-hexylaniline to synthesize 4,4′-dihexylazobenzene and then reacted with N-bromosuccinimide. An azobenzene derivative (6) may be obtained by reacting methylboronic acid in the presence of a Pd catalyst and a base.

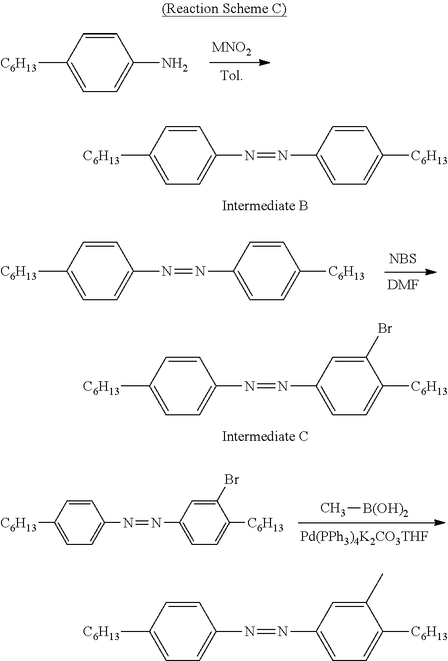

These azobenzene derivatives may be used alone or in combination of two or more.

### (2.2) Azobenzene-Containing Polymer Compound

In the present invention, it is preferable to use an azobenzene-containing polymer compound (hereinafter, also referred to as an azobenzene derivative 2 in the present invention) obtained by polymerizing an azobenzene derivative having a polymerizable group. As the azobenzene derivative having a polymerizable group, an azobenzene derivative having a polymerizable group having a structure represented by the following Formula (2) is preferable. In Formula (2), examples of the polymerizable group include (meth)acryloyl group, epoxy group, and vinyl group sugar.

The number of polymerizable groups contained in one molecule may be one or two or more. In particular, the number of polymerizable groups contained in one molecule of the azobenzene derivative having a polymerizable group is preferably one, from the viewpoint of easily obtaining a polymer compound which is easy to melt even if the amount of light irradiation energy is low. That is, it is preferable that it is a monofunctional polymerizable monomer.

Formula (2)

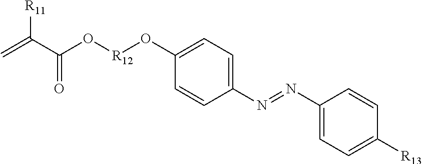

In Formula (2), R₁₁ represents a hydrogen atom or a methyl group. Ru represents a straight-chain alkyl group having 1 to 12 carbon atoms. R₁₃ represents a hydrogen atom, an alkyl group having 1 to 4 carbon atoms, or an alkoxy group having 1 to 4 carbon atoms.

Examples of a straight-chain alkyl group having 1 to 12 carbon atoms represented by R₁₂ include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, and an n-hexadecyl group.

Examples of an alkyl group having 1 to 4 carbon atoms and an alkoxy group having 1 to 4 carbon atoms represented by R₁₃ are synonimous with an alkyl group having 1 to 4 carbon atoms and an alkoxy group having 1 to 4 carbon atoms described for Formula (1). When R₁₃ is a group in which the carbon chain is too long or is a group that easily interacts, in the polymer compound, R₁₃s of different molecules tend to be entangled with each other or interact with each other, and photoisomerization may be difficult to occur. From the viewpoint of avoiding such problems, R₁₃ is preferably a group having a relatively short carbon chain or a group that is difficult to interact with, and it is preferably that R₁₃ is a hydrogen atom, an alkyl group having 1 to 4 carbon atoms, or an alkoxy group having 1 to 4 carbon atoms.

The number average molecular weight Mn of the azobenzene-containing polymer compound is not particularly limited. For example, it is preferably in the range of 2,000 to 100,000, more preferably in the range of 3,000 to 75,000, still more preferably in the range of 4,000 to 50,000. The number average molecular weight Mn may be measured by gel permeation chromatography (GPC) described later.

Specific examples of the azobenzene-containing polymer compound obtained by polymerizing an azobenzene derivative having a polymerizable group include the following compounds (13) to (20). However, the present invention is not limited to them.

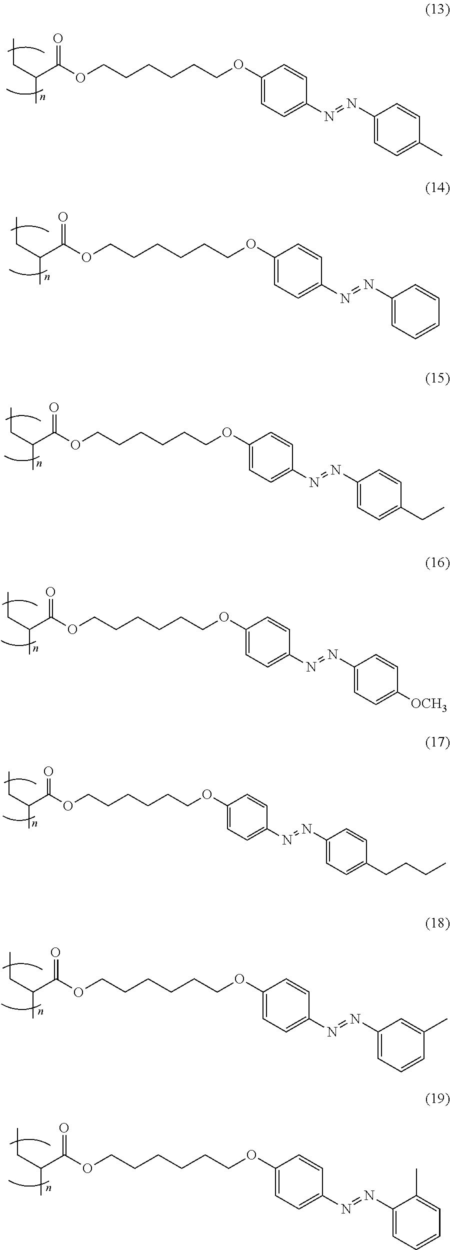

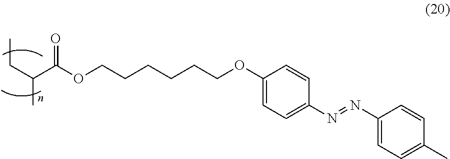

### (2.3) Polymer Compound Having a Branched Chain of Hexaarylimidazole Group

In the present invention, a polymer compound having a structure represented by Formula (3) described later may be preferably used as the photosoftening compound. The aforesaid polymer compound is a compound having a bond that is cleaved by light absorption.

The aforesaid polymer compound is obtained by crosslinking a precursor polymer having a branched structure, and the precursor polymer has at least one branched chain having a triphenylimidazole group only at the end. The crosslinked polymer has a structure in which the molecules are crosslinked by bonding of the triphenylimidazole groups between molecules.

Here, the precursor polymer is, for example, a compound having a fluidity at a temperature of 5 to 50° C., i.e., a liquid state. Cross-linking between the molecules results in solid non-flowing crosslinked polymer.

Then, when the cross-linked polymer is irradiated with ultraviolet light, the cross-linking (covalent bond) in the triphenylimidazole group may be cleaved to change from the solid state to the liquid state. Further, by stopping the ultraviolet irradiation and leaving it to stand at room temperature (for example, 20 to 25° C.), crosslinking may be spontaneously formed again to return to the crosslinked polymer in the solid state. By utilizing this phenomenon, the fluidity of the crosslinked polymer may be reversibly controlled by ultraviolet irradiation.

In the present invention, “crosslinked polymer that changes from solid state to liquid state by ultraviolet irradiation” refers to a crosslinked polymer whose melting or softening is visually confirmed by the following method. That is, it is a method as follows. The crosslinked polymer in a solid state is placed on a slide glass, and the crosslinked polymer is irradiated with ultraviolet light so that the light quantity is 10 J/cm² using an LED light source with a maximum emission wavelength of 365 nm, and then observed visually.

The wavelength range of ultraviolet light used in the present invention is preferably in the range of 10 to 480 nm, more preferably in the range of 300 to 480 nm, still more preferably in the range of 300 to 420 nm.

As the backbone polymer constituting the main chain of the precursor polymer used in the present invention, one which is in a state of melting or softening at normal temperature is used. As such a backbone polymer, those known in the art may be used. Examples of the backbone polymer are a compound having a polyacrylate structure, a polymethacrylate structure, a polystyrene structure, a polyethylene structure, a polyamide structure, a polyester structure, a polyurethane structure, or a polysiloxane structure. Preferably, it is a polyacrylate structure or a polysiloxane structure, more preferably a poly(alkyl acrylate)structure or a polydimethylsiloxane (PDMS) structure. The precursor polymer is one having a branched structure, preferably a four-branched structure. By having a four-branched structure, the degree of freedom in molecular design such as the introduction of a triphenylimidazole group and the introduction of other substituents is increased, and the three-dimensional structure of a crosslinked polymer can be easily controlled. Therefore, the advantage is obtained that the image intensity in the solid state and the fluidity in the liquid state may be controlled.

The precursor polymer used in the present invention preferably has a number average molecular weight (Mn) in the range of 1,000 to 500,000, more preferably in the range of 3,000 to 100,000 from the viewpoint of being in a liquid state having fluidity at normal temperature. The number average molecular weight (Mn) of the precursor polymer may be measured using gel permeation chromatography (GPC) using polystyrene as a standard substance.

The precursor polymer used in the present invention has at least one branched chain having a triphenylimidazole group only at the end. The triphenylimidazole group is a 2,4,5-triphenylimidazole group and has the following structure.

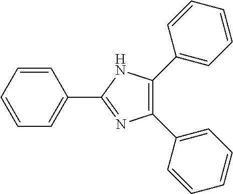 [SMILES: c1ccc(-c2nc(-c3ccccc3)c(-c3ccccc3)[nH]2)cc1]

Each phenyl group in the triphenylimidazole group may be independently substituted with 1 to 5 identical or different substituents. Examples of the substituent include, for example, a substituent selected from the group consisting of a halogen atom, an alkyl group which may be substituted, an alkenyl group, an aryl group, a sulfo group, a carboxy group, an ester group and an amide group, which may be substituted. In the present specification, the “alkyl group” may be any of straight-chain, branched, cyclic, or a combination of aliphatic hydrocarbon groups. The carbon number of the alkyl group is not particularly limited, and it is, for example, 1 to 20 carbon atoms, 3 to 15 carbon atoms, or 5 to 10 carbon atoms. In the present specification, the “aryl group” may be any of monocyclic or fused polycyclic aromatic hydrocarbon group, and it may be an aromatic heterocycle containing one or more hetero atoms (e.g., oxygen atom, nitrogen atom, or sulfur atom) as a ring constituting atom. In this case, this may be referred to as “heteroaryl group” or “heteroaromatic group”. Whether an aryl group is a single ring or a fused ring, it may be bonded at all possible positions.

The triphenylimidazole group is introduced to at least one end of the branched chain of the precursor polymer, but is preferably introduced to the ends of two or more branched chains For example, in the case of a polyacrylate having a four-branched structure, it is preferable to introduce a triphenylimidazole group at each end of four branched chains The number of such triphenylimidazole groups may be changed according to the desired physical properties of the crosslinked polymer.

From the viewpoint of easily obtaining the effects of the present invention, preferred examples of the precursor polymer used in the present invention include precursor polymers represented by the following Formula (3).

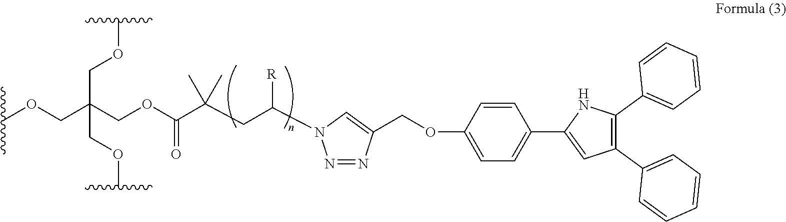

In Formula (3), R is a carboxylic acid ester group, n is an integer of 2 to 200. All four branched chains have the same structure.

The above R is a carboxylic acid ester group. Examples of the carboxylic acid ester group include, for example, a methoxycarbonyl group (—COOCH₃), an ethoxycarbonyl group (—COOC₂H₅), an n-butoxycarbonyl group (—COO(n-C₄H₉)), an n-hexyloxycarbonyl group (—COO(n-C₆H₁₃)). Preferably, it is an n-butoxycarbonyl group (—COO(n-C₄H₉)).

In Formula (3), n is an integer of 2 to 200, preferably it is an integer of 2 to 20.

The four branched chains in the above Formula (3) all have the same structure (R and n are the same for the four branched chains), but the precursor polymer used in the present invention does not necessarily have a triphenylimidazole group at the end of every branched chain (polyacrylate chain). In addition, the lengths of branched chains (polyacrylate chains), that is, the value of n are not necessarily the same in each branched chain, and may be different.

Using a polyacrylate having a 4-branched structure represented by Formula (3) as a precursor polymer, for example, a cross-linked polymer cross-linked between molecules in a triphenylimidazole group by ultraviolet irradiation has a structure represented by Formula (A).

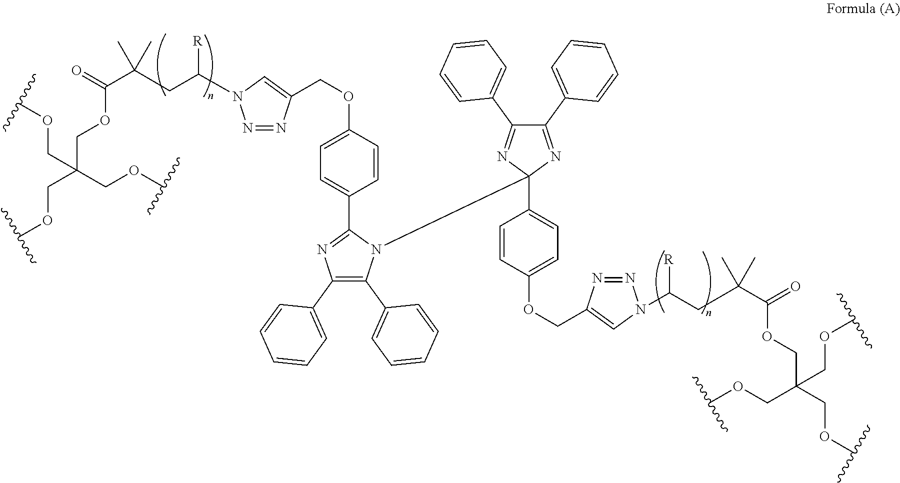

In Formula (A), R and n have the same definitions as in Formula (3). The crosslinked polymers according to the present invention may be used alone or in combination of two or more.

### (2.4) Thermoresponsive Material

The thermoresponsive material according to the present invention refers to a material whose shape or color is changed by heat.

Examples of the heat responsive material include Advancell manufactured by Sekisui Chemical Co., Ltd., Expanse manufactured by AkzoNobel Ltd. (Netherlands), Matsumoto Microsphere manufactured by Matsumoto Yushi-Seiyaku Co., Ltd., Kureha Microsphere manufactured by Kureha Co., Ltd., Sakura TC color manufactured by Sakura Color Products Corp. These may be used in the present invention. However, the present invention is not limited to them.

### (3) Thermoplastic Resin

The layer containing the photosoftening compound preferably further contains a resin as a binder resin. In addition to the resin, other components such as a colorant, a dispersant, a surfactant, a plasticizer, a releasing agent, and an antioxidant may be contained in the layer.

The resin may be one that is softened or plasticized by light. As such a resin, for example, a thermoplastic resin that is plasticized by heat generated by light irradiation, and a heat-fusible resin that is melted by heat generated by light irradiation may be mentioned.

The thermoplastic resin may be a known resin having thermoplasticity and is not particularly limited. Further, as the heat-fusible resin, a known resin having heat-fusible property may be used, and it is not particularly limited.

Examples of the thermoplastic resin and the heat-fusible resin include: (meth)acrylic resin, styrene resin, styrene-acrylic resin, olefin resin (including cyclic olefin resin), polyester resin, polycarbonate resin, polyamide resin, polyphenylene ether resin, polyphenylene sulfide resin, halogen-containing resin (polyvinyl chloride, poly vinylidene chloride, and fluorine resin), polysulfone resin (polyether sulfone and polysulfone), cellulose derivative (cellulose ester, cellulose carbamate, and cellulose ether), silicone resin (polydimethylsiloxane and polymethylphenyl siloxane), polyvinyl ester resin (polyvinyl acetate), acrylonitrile-butadiene-styrene copolymer (ABS resin), polyvinyl alcohol resin and derivatives thereof, rubber and elastomer (diene rubber such as polybutadiene and polyisoprene, styrene-butadiene copolymer, acrylonitrile-butadiene copolymer, acrylic rubber, and urethane rubber). The thermoplastic resin and the heat-fusible resin may be used alone or in combination of two or more. In the present specification, “(meth)acrylic” refers to “acrylic and/or methacrylic”.

The thermoplastic resin and the heat-fusible resin may be a copolymer. When the thermoplastic resin is a copolymer, the form of the copolymer may be any of a block copolymer, a random copolymer, a graft copolymer, and an alternating copolymer.

Further, as the thermoplastic resin and the heat-fusible resin, a synthetic product may be used or a commercially available product may be used. The polymerization method for synthesizing these thermoplastic resin and heat-fusible resin is not particularly limited, and known methods may be used. For example, high pressure radical polymerization method, medium and low pressure polymerization method, solution polymerization method, slurry polymerization method, bulk polymerization method, emulsion polymerization method, and gas phase polymerization method may be mentioned. Also, the radical polymerization initiator and catalyst used during polymerization are not particularly limited. For example, radical polymerization initiators such as azo or diazo polymerization initiators and peroxide polymerization initiators; polymerization catalysts such as peroxide catalysts, Ziegler-Natta catalysts, and metallocene catalysts may be used.

From the viewpoint of easily controlling the surface state of the photo softening compound-containing layer in the light irradiation step, the thermoplastic resin and the heat-fusible resin contain, among the above-mentioned resins, at least one selected from the group consisting of (meth) acrylic resin, styrene resin, styrene-acrylic resin, and polyester resin. More preferably, they contains at least one selected from the group consisting of styrene-acrylic resin and polyester resin.

The styrene-acrylic resin referred to in the present invention is formed by polymerization using at least a styrene monomer and a (meth) acrylic acid ester monomer. In this specification, the styrene monomer indicates styrene represented by the formula CH₂═CH—C₆H₅, and also includes monomers having a known side chain or functional group in a styrene structure.

Moreover, a (meth)acrylic acid ester monomer is a monomer having a functional group which has an ester bond in a side chain. Specifically, in addition to an acrylic acid ester monomer represented by CH₂═CHCOOR (R is an alkyl group), a vinyl ester compound such as a methacrylic acid ester monomer represented by CH₂═C(CH₃)COOR (R is an alkyl group) is included.

In the styrene-acrylic resin, besides the copolymer formed only of the above-mentioned styrene monomer and (meth)acrylic acid ester monomer, copolymers formed using further common vinyl monomers (olefins, vinyl esters, vinyl ethers, vinyl ketones, and N-vinyl compounds) are included.

Further, in the styrene-acrylic resin, copolymers formed with a multifunctional vinyl monomer and a vinyl monomer having an ionic dissociative group (a carboxy group, a sulfonic acid group, or a phosphoric acid group) in a side chain in addition to a styrene monomer, a (meth)acrylic acid ester monomer and other common vinyl monomer. Examples of such vinyl monomers include, for example, acrylic acid, methacrylic acid, maleic acid, and itaconic acid.

The polyester resin is a known polyester resin obtained by the polycondensation reaction of a divalent or higher valent carboxylic acid (polyvalent carboxylic acid component) and an alcohol having a divalent or higher valent (polyhydric alcohol component). The polyester resin may be amorphous or crystalline. The number of valences of the polyvalent carboxylic acid component and the polyhydric alcohol component is preferably 2 to 3, and particularly preferably it is respectively 2. Therefore, the case where the valence number is 2 (i.e., the dicarboxylic acid component and the diol component) will be described as a particularly preferred embodiment. Examples of the dicarboxylic acid component include: saturated aliphatic dicarboxylic acids such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1,18-octadecanedicarboxylic acid; unsaturated aliphatic dicarboxylic acids such as methylenesuccinic acid, fumaric acid, maleic acid, 3-hexendiodic acid, 3-octendioic acid, and dodecenyl succinic acid; and unsaturated aromatic dicarboxylic acids such as phthalic acid, terephthalic acid, isophthalic acid, t-butyl isophthalic acid, tetrachlorophthalic acid, chlorophthalic acid, nitrophthalic acid, p-phenylenediacetic acid, 2,6-naphthalenedicarboxylic acid, 4,4′-biphenyldicarboxylic acid, and anthracene dicarboxylic acid. In addition, lower alkyl esters and acid anhydrides of these compounds may also be used. The dicarboxylic acid components may be used alone or in combination of two or more.

In addition, trivalent or higher polyvalent carboxylic acids such as trimellitic acid and pyromellitic acid, anhydrides of the above carboxylic acid compounds, and alkyl esters having 1 to 3 carbon atoms may also be used.

Examples of the diol component include: saturated aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,20-eicosandiol, and neopentyl glycol; unsaturated aliphatic diols such as 2-butene-1,4-diol, 3-butene-1,4-diol, 2-butyne-1,4-diol, 3-butyne-1,4-diol, and 9-octadecene-7,12-diol; aromatic diols such as bisphenols (bisphenol A and bisphenol F), and alkylene oxide adducts of these compounds (ethylene oxide adduct and propylene oxide adduct), and derivatives thereof. The diol components may be used alone or in combination of two or more. The method for producing the polyester resin is not particularly limited, and examples thereof include a method of polycondensation (esterification) of the polyvalent carboxylic acid component and the polyhydric alcohol component using a known esterification catalyst.

The weight average molecular weight of the resin contained in the photosoftening compound-containing layer is not particularly limited, but is preferably in the range of 2,000 to 1,000,000, more preferably in the range of 5,000 to 100,000, and particularly preferably in the range of 10,000 to 50,000.

### (Weight Average Molecular Weight (Mw) and Number Average Molecular Weight (Mn))

The resin to be measured was dissolved in tetrahydrofuran (THF) to a concentration of 1 mg/mL, and then filtered using a membrane filter with a pore size of 0.2 μm, and the resulting solution was used as a sample for GPC measurement. GPC analysis conditions indicated below were adopted for the GPC measurement conditions, and a weight average molecular weight or a number average molecular weight of resin contained in a sample were measured.

### (GPC Measurement Conditions)

As a GPC apparatus, “HLC-8120GPC, SC-8020” (made by Tosoh Corporation) was used. Two pieces of “TSKgel, Super HM-H” (6.0 mmID×15 cm, made by Tosoh Corporation) were used as columns Tetrahydrofuran (THF) was used as an eluent. The analysis was performed at a flow rate of 0.6 mL/min, a sample injection amount of 10 μL, and a measurement temperature of 40° C. using a RI detector. The calibration curve was obtained by using “Polystyrene standard sample, TSK standard” manufactured by Tosoh Corporation. Ten samples of “A-500”, “F-1”, “F-10”, “F-80”, “F-380”, “A-2500”, “F-4”, “F-40”, “F-128” and “F-700” were use. The data collection interval in sample analysis was 300 ms.

The content of the resin in the photosoftening compound-containing layer is not particularly limited. From the viewpoint of softening the surface of the photosoftening compound-containing layer in the light irradiation step to facilitate control of the surface state of the photosoftening compound-containing layer, it is preferable that the content of the resin is in the range of 0 to 95 mass % with respect to the total mass of the photosoftening compound-containing layer. More preferably, it is in the range of 0 to 50 mass %, still more preferably, it is in the range of 5 to 50 mass %, and most preferably, it is in the range of 10 to 50 mass %

On the other hand, when the photosoftening compound-containing layer contains other components (for example, a colorant and a releasing agent) together with the resin, the content of the other components is not particularly limited. From the viewpoint of melting or softening the surface of the photosoftening compound-containing layer in the light irradiation step to facilitate control of the surface state of the photosoftening compound-containing layer, it is preferable that the content of the other components is in the range of 3 to 40 mass % with respect to the total mass of the photosoftening compound-containing layer. More preferably, it is in the range of 5 to 20 mass %

The colorant as the other component is not particularly limited, and known dyes and pigments may be used. Examples of the colorant include: carbon black, magnetic material, and iron-titanium complex oxide black; dyes such as C. I. Solvent Yellow 19 and 44; pigments such as C. I. Pigment Yellow 14 and 17; dyes such as C. I. Solvent Red 1 and 49; pigments such as C. I. Pigment Red 5 and 122; dyes such as C. I. Solvent Blue 25 and 36; and pigments such as C. I. Pigment Blue 1 and 7. The colorants are not limited to them.

The releasing agent as the other component is not particularly limited, and a known releasing agent may be used. Examples of the releasing agent include: polyolefin waxes such as polyethylene wax and polypropylene wax; branched hydrocarbon waxes such as microcrystalline wax; long-chain hydrocarbon waxes such as paraffin wax and SASOL wax; dialkyl ketone waxes such as distearyl ketone; ester waxes such as carnauba wax, montan wax, behenyl behenate, trimethylolpropane tribehenate, pentaerythritol tetrabehenate, pentaerythritol diacetate dibehenate, glycerol tribehenate, 1,18-octadecanediol distearate, tristearyl trimellitate, and distearyl maleate; and amide waxes such as ethylenediaminebehenylamide and trimellitic tristearylamide. The present invention is not limited to them.

The thickness of the photosoftening compound-containing layer is not particularly limited, and it is preferably, for example, in the range of 1 to 100 μm, and more preferably in the range of 1 to 50 μm. When the thickness of the photosoftening compound-containing layer is in the above range, the orientation of the powder may be more easily controlled, and the texture may be easily controlled.

### (4) Powder

In the image forming method of the present invention, the powder may be appropriately selected according to the purpose of decoration and the desired texture. Here, the powder refers to an aggregate of particles, and also refers to a substance that remains in the form of powder in the final image.

### (4.1) Details of Powder

The shape and size of the powder supplied onto the photosoftening compound-containing layer are not particularly limited, and it is preferable to select an appropriate shape and size to achieve the desired texture.

Powders are roughly classified into spherical (spherical powder) or non-spherical (non-spherical powder) from the viewpoint of shape. The “spherical powder” refers to a powder having an average circularity of 0.970 or more in its cross-sectional shape or projected shape (upper limit: 1.000). The average degree of circularity may be determined according to the “Wadell's equation”, but it may be a value measured using, for example, the following flow type particle image analyzer “FPIA-3000” (manufactured by Sysmex Corporation). Specifically, a measuring sample powder is wetted in an aqueous surfactant solution, and is ultrasonically dispersed for one minute. After making the dispersion, the average circularity is measured with the analyzer “FPIA-3000” in a high power field (HPF) mode at an appropriate density (the number of particles to be detected at an HPF: 4000 particles). The circularity is calculated from the following expression.

Circularity=(Perimeter of a circle having the same projected area as the particle image)/(Perimeter of the projected image of the particle)

The average circularity indicates an arithmetic average value obtained by dividing the sum of circularities of particles by the number of particles. Therefore, “non-spherical powder” refers to a powder other than a spherical powder and has an average circularity of less than 0.970 in its cross-sectional shape or projected shape.

Among them, the shape of the powder is preferably non-spherical from the viewpoint of achieving the desired texture (in particular, from the mirror tone-pearl tone to the glitter tone) by controlling the orientation of the powder. That is, it is preferable that the powder contains non-spherical powder. Further, from the same viewpoint, it is more preferable that the non-spherical powder includes a flat powder (that is, particles having a flat shape). Here, “flat” or “flat shape” refers to a shape having a ratio of (1/t) is 5 or more, provided that the maximum length of the powder (particles) is a major axis L, the maximum length in the direction orthogonal to the major axis L is a minor axis 1, and the minimum length in the direction orthogonal to the major axis L is thickness t. The terms “flat” or “flat shape” include, for example, shapes called flake, scale, plate, and thin layer.

The average thickness of the flat powder is not particularly limited, and it is preferably in the range of 0.2 to 10 μm from the viewpoint of facilitating the adjustment of the texture of gloss by controlling the orientation of the powder. More preferably, it is in the range of 2 to 3.0 μm.

By setting the average thickness to 0.2 μm or more, a good orientation state may be formed. Specifically, it is easy to control so that the flat surface of the flat powder (that is, the plane including the above-mentioned major axis L direction and the above minor axis 1 direction) is along the surface of the photosoftening compound containing layer. On the other hand, by setting the average thickness to 10 μm or less, when the final image to be formed is rubbed, it is possible to suppress the falling off of the powder from the photosoftening compound-containing layer.

The average particle diameter of the powder (when the powder is non-spherical powder, the average value of the length of the longest part in linear distance) is preferably in the range of 0.5 to 1,000 μm, more preferably in the range of 1 to 500 μm, still more preferably in the range of 5 to 100 μm. Within such a range, it is possible to develop a wide range of textures, such as mirror tone-pearl tone (metallic gloss with little irregular reflection) to glitter tone (metallic gloss with frequent irregular reflection) in an image having sufficient gloss. In addition, as the average particle diameter of the powder is smaller, the texture of mirror tone-pearl tone may be expressed, and as the average particle diameter of the powder is larger, the texture of glitter tone may be expressed.

The average thickness of the powder is an average value of a thickness optionally measured for 100 powder particles, and the average particle diameter of the powder is an average value of a particle diameter optionally measured for 100 powder particles. The thickness and particle size (including the major axis and the minor axis) of each powder particle can be measured, for example, by scanning electron microscope (SPM: Scanning Probe Microscope) observation. In addition, for the values of major axis, minor axis and thickness of flat powder, an average value of the values measured by the above method is adopted.

The material of the powder is not particularly limited, and for example, various materials such as resin, glass, metal, and metal oxide may be used. Among them, the powder preferably contains a metal or a metal oxide. When a metal or metal oxide is included, a wide range of textures such as mirror tone-pearl tone (metallic gloss with less irregular reflection) to glitter tone (metallic gloss with frequent irregular reflection) may be developed in an image having sufficient gloss.

In addition, the material constituting the powder may be one kind alone, or two or more kinds. When the powder contains two or more kinds of materials, it may be in the form of being uniformly dispersed, or in the form in which one material is laminated (coated) with another material. As such a form, for example, a form in which a film (shell) made of metal and metal oxide is laminated on a base material (core) made of resin, or glass; and a form in which a film (shell) made of resin, or glass is laminated on a base material (core) made of metal or metal oxide are cited. However, the form is not limited to them.

The aforesaid powder may be a synthetic product or a commercially available product. Examples of non-spherical powder include: METASHINE (registered trademark) (Nippon Sheet Glass Co., Ltd.), Sunshine baby chrome powder, Aurora powder, Pearl powder (GG Corporation), ICEGEL Mirror Metal Powder (TAT Corporation), PIKA ACE (registered trademark) MC Shine Dust, Effect C (Kurachi Co., Ltd.), PREGEL (registered trademark), Magic Powder, Mirror series (Preanfa Co., Ltd.), Bonnail (registered trademark), Shine Powder (Kay's Planning, Inc.), and LG neo (registered trademark) (Oike & Co., Ltd.). Examples of the spherical powder include high-precision Unibeads (registered trademark) (Unitika, Ltd.) and Fine sphere (registered trademark) (manufactured by Nippon Electric Glass Co., Ltd.).

In addition, only 1 type may be sufficient as the powder supplied on a photosoftening compound-containing layer, and 2 or more types may be mixed and used.

### (4.2) Powder Supply Step

(1) The powder supply step is appropriately selected from either supplying powder in advance onto a recording medium, or supplying powder onto the aforesaid photosoftening compound-containing layer formed on the recording medium. The method for supplying the powder is not particularly limited, and a known device may be used according to the properties of the powder as the powder supply means in the powder supply step. For example, the powder supply means described in JP-A 2013-178452 (the above-mentioned Patent Document 3) may be used as the powder supply means according to the present invention. In addition, the powder supply means according to an embodiment of the present invention may be a powder supply device 10 including a powder container 11 and a powder supply roller 12 as indicated in FIG. 1 to FIG. 3.

A specific example of the powder supplying method is as follows. When the powder is an insulating powder, the positively or negatively charged insulating powder is supplied from the powder container 11 to the conductive powder supply roller (conductive roller) 12, then the above-mentioned insulating powder supported and transported by the conductive roller is supplied onto the photosoftening compound-containing layer. That is, when the powder is an insulating powder, use a powder supply device (powder supply means) 10 having a powder container 11 and a conductive powder supply roller (conductive roller) 12 is preferred.

Another specific example of the powder supplying method is as follows. When the powder is a magnetic powder, the magnetic powder is supplied from the powder container 11 to the powder supply roller (magnet roller) 12 having magnetism, and the magnetic powder supported and conveyed by the magnet roller is supplied on the photosoftening compound-containing layer. That is, when the powder is a magnetic powder, it is preferable to use a powder supply device (powder supply means) 10 having a powder container 11 and a powder supply roller (magnet roller) 12 having magnetism.

The amount of the powder to be supplied to the photosoftening compound-containing layer is not particularly limited, and it is not particularly limited as long as it expresses the desired texture.

The powder may be selectively supplied only on the photosoftening compound-containing layer, or it may be supplied not only on the photosoftening compound-containing layer, but also on the entire surface of the recording medium including the portion where the photosoftening compound-containing layer is not formed. Further, the powder may be supplied only to the portion irradiated with light (i.e., the portion imparting glossiness) on the photosoftening compound-containing layer, and the powder may be supplied to the entire surface of the photosoftening compound-containing layer including not only the part irradiated with light but also the part not irradiated with light.

In the image forming method according to one aspect of the present invention, only the photosoftening compound-containing layer in the portion irradiated with light is softened by the light irradiation step, and the powder can be selectively attached to the portion. Therefore, since the powder does not adhere to the portion to which light is not irradiated, the powder may be easily removed or recovered even if the powder is supplied to a portion other than the portion that imparts gloss.

### (5) Light Irradiation Step

In the image forming method of the present invention, the photosoftening compound-containing layer is irradiated with light to bring the photosoftening compound-containing layer into a melted or softened state.

The light irradiation step is performed before or after the powder supply step. In the light irradiation step, the photosoftening compound-containing layer is irradiated with light to melt or soften the photosoftening compound-containing layer.

In this step, since it is sufficient to soften the vicinity of the surface of the photosoftening compound-containing layer in order to adhere the powder, it is preferable to irradiate light from the surface side (opposite to the recording medium) of the photosoftening compound-containing layer.

The light irradiated to the photosoftening compound-containing layer is not particularly limited as long as it will soften at least the surface of the photosoftening compound-containing layer, and ultraviolet light, visible light, and infrared light may be used. Among them, it is preferable to use ultraviolet light from the viewpoint of easy handling and the ability to soften the photosoftening compound-containing layer at a sufficient speed. That is, it is preferable that the light irradiated in a light irradiation step is an ultraviolet light. The wavelength range of the ultraviolet light used in the present invention is preferably in the range of 10 to 480 nm, more preferably in the range of 300 to 480 nm, and still more preferably in the range of 300 to 420 nm.

The amount of light to be irradiated (the total amount of light irradiation energy, referred to as the light amount in the present invention) is not particularly limited, and it is appropriately adjusted to form a glossy image having a desired texture. At this time, since the surface of the photosoftening compound-containing layer is more likely to melt or soften as the amount of light increases, the orientation of the powder adhering to the photosoftening compound-containing layer tends to be irregular and the light reflection distribution tends to spread. As a result, it becomes easy to express a glitter-like texture with many irregular reflections. On the other hand, the smaller the amount of light, the smaller the extent to which the surface of the photosoftening compound-containing layer is melted or softened, and the powder on the photosoftening compound-containing layer is more likely to be oriented along the surface of the photosoftening compound-containing layer, and the light reflection distribution tends to be narrow. As a result, it becomes easy to express a pearly or mirror-like texture with few irregular reflections.

From the viewpoint of facilitating control of the powder orientation in order to achieve desired texture (particularly, mirror tone-pearl tone to glitter tone) efficiently, the amount of light to be applied is, for example, in the range of 0.01 to 100 J/cm², more preferably in the range of 0.1 to 50 J/cm², and particularly preferably in the range of 0.5 to 15 J/cm².

As described above, in the light irradiation step, it is preferable to control the amount of light in order to obtain the desired texture. In other words, the image forming method of the present invention is able to express a very wide range of texture using the same powder by controlling the amount of light. Such control of the light quantity may be performed, for example, by appropriately adjusting the light intensity, the irradiation time, and the distance from the light source to the photosoftening compound-containing layer.

The intensity (illuminance) of the light to be irradiated is suitably adjusted in order to achieve the desired texture, as in the case of the light amount. The intensity (illuminance) of the light to be irradiated is appropriately selected from the viewpoint of facilitating control of the powder orientation in order to efficiently achieve the desired texture (in particular, from mirror tone-pearl tone to glitter tone).

The irradiation time of light is not particularly limited, and the distance from the light source to the photosoftening compound-containing layer is not particularly limited, and is adjusted.

The aforesaid control of the light amount includes changing the light amount stepwise or continuously in one photosoftening compound-containing layer. That is, it is preferable that a light irradiation step includes irradiating light with a light quantity which is different for every part on a photosoftening compound-containing layer. For example, in one photosoftening compound-containing layer, when the light quantity is changed stepwise, a pearl-like texture is formed in one part and a glitter-like texture is formed in the other part. Thus, it is possible to obtain different parts having different textures. As described above, according to the image forming method of the present invention, there is an advantage that a plurality of textures may be formed in one-pass by changing the light amount.

In addition, the aforesaid control of the light amount may also include partially irradiating light to one photosoftening compound-containing layer. As described above, by partially irradiating light to one photosoftening compound-containing layer, it is possible to efficiently create a part to which gloss is to be imparted and a part that is not.

The light irradiation means used in the light irradiation step is not particularly limited, and a known device may be used. As illustrated in FIG. 1 to FIG. 3, the light irradiation device 20-1 or 20-2 as light irradiation means according to the present invention is provided in front of the powder supply device (powder supply means) 10 in the conveyance direction of the recording medium. Otherwise, it may be provided after the powder supply device (powder supply means) 10. The arrangement order of these devices is appropriately determined according to the order in which the powder supply step and the light irradiation step are performed.

The light irradiation device 20-1 or 20-2 (sometimes referred to as “light source” in this specification) as light irradiation means for irradiating light is not particularly limited as long as it can irradiate light for softening the photosoftening compound-containing layer. Examples of the light irradiation device include: light emitting diode (LED) lamp, low pressure mercury lamp, high pressure mercury lamp, super high pressure mercury lamp, metal halide lamp, chemical lamp, halogen lamp, mercury-xenon lamp, carbon arc lamp, argon laser, excimer laser, YAG laser, and dye laser. Among these, LED lamps and lasers are preferred.

The light irradiation may be performed while the recording medium on which the photosoftening compound-containing layer is formed is allowed to stand or may be moved. As a method of irradiating light while moving the recording medium, for example, a method of irradiating light while moving the recording medium by a conveying means such as a belt conveyor may be mentioned. The method is appropriately adjusted from the viewpoint of productivity, suppression of damage to recording medium, melting or softening state of photosoftening compound-containing layer on recording medium.

In addition, light may be emitted once or twice or more. That is, the light may be irradiated only once to a part on the photosoftening compound-containing layer, or the light may be irradiated twice or more. However, when light is irradiated a plurality of times, the softened photosoftening compound-containing layer may be cured even with the same amount of light, so the number of times of light irradiation is preferably one.

### (6) Rubbing Step

The image forming method of the present invention preferably includes a rubbing step of rubbing the photosoftening compound-containing layer supplied with the powder, in addition to the powder supply step and the light irradiation step. From the viewpoint of expressing a wide range of textures such as mirror tone-pearl tone (metallic gloss with little diffuse reflection) to glitter tone (metallic gloss with diffuse reflectance), i.e., from the viewpoint of widening the control range of texture, the image forming method according to an aspect of the present invention preferably further includes a rubbing step. Specifically, “the control range of the texture is wide” means that the half-width value of the peak obtained by measuring the distribution of the reflected light (received light) from the image and the value of the glossiness of the image each can be controlled over a wide range. For example, when the cases having a half-width of 5 to 20° and 10 to 15° are compared, it can be said that the former has a wider control range of texture.

### (Distribution Measurement of Reflected Light)

A reflection measurement for measuring the reflected light (received) angle at an incident angle of 20° is done using a variable angle photometer “GP-5” (Murakami Color Research Laboratory, Inc.), and a half-width of the peak may be determined by performing the measurement in the receiving angle of —10 to 50°.

The rubbing step is a step of rubbing the photosoftening compound-containing layer in the state of adhering the powder from above the powder, and it is performed after the powder supply step and the light irradiation step. Here, the term “rubbing” means that the rubbing means (rubbing member) is in contact with the surface of the photosoftening compound-containing layer on the recording medium, and the rubbing means relatively moves along the surface with respect to the photosoftening compound-containing layer.

By rubbing the photosoftening compound-containing layer in the state in which the powder adheres in this manner from above the powder, the powder may be orientated with respect to the surface of the photosoftening compound-containing layer. More specifically, by rubbing, the angle of the powder with respect to the surface of the photosoftening compound-containing layer may be easily aligned, and a desired texture such as mirror tone or pearl tone with less irregular reflection may be easily formed. In particular, when the powder is a flat powder, the flat surface can be oriented along the surface of the photosoftening compound-containing layer, so that the desired texture such as mirror tone and pearl tone with less irregular reflection is more effectively formed.

Therefore, the image forming method of the present invention preferably further includes a rubbing step of rubbing the photosoftening compound-containing layer supplied with the powder after the powder supply step and the light irradiating step.

Moreover, it is preferable that the said “rubbing” is accompanied by the press of the photosoftening compound-containing layer (the photosoftening compound containing-layer to which the powder is adhered). That is, the rubbing step preferably includes rubbing and pressing the photosoftening compound-containing layer supplied with the powder. By pressing the photosoftening compound-containing layer, a part of the powder is pushed into the inside of the photosoftening compound-containing layer, so the adhesion of the powder to the photosoftening compound-containing layer may be strengthened. Therefore, in addition to the improvement of the strength of the finally formed glossy image, it is possible to make clear the expected appearance such as mirror tone or pearl tone in the formed glossy image. Here, “pressing” refers to pressing the surface of the photosoftening compound-containing layer in a direction (e.g., perpendicular direction) intersecting the surface of the photosoftening compound-containing layer.

The rubbing step is performed by rubbing the photosoftening compound-containing layer to which the powder is adhered, using a rubbing means. Specifically, in the rubbing step, a rubbing member as a rubbing means is brought into contact with the photosoftening compound-containing layer to which the powder is adhered, and rubbing is performed by making the rubbing member to move relative to the photosoftening compound-containing layer. At this time, the direction in which the rubbing member is moved is not particularly limited, and may be in only one direction, may be reciprocated, or may be in more directions. However, in order to easily control the orientation of the powder and form a texture such as mirror tone or pearl tone with less irregular reflection, it is preferable that the sliding member move in only one direction.

In the control step, as described above, it is preferable to control the rubbing condition for the purpose of expressing a wide range of textures such as mirror tone-pearl tone to glitter tone. At this time, the rubbing condition includes the rubbing speed (the relative speed of the rubbing portion of the rubbing member with respect to the surface of the photosoftening compound-containing layer), the pressing force and the like. Further, as described below, when using a rotating member as the rubbing member, it is preferable to control the rotational speed as the rubbing condition.

In the rubbing step, the relative velocity of the rubbing portion of the rubbing member to the surface of the photosoftening compound-containing layer is not particularly limited, but is preferably in the range of 5 to 500 mm/sec. When it is 5 mm/sec or more, the orientation of the powder may be sufficiently performed to the surface of the photosoftening compound-containing layer. In addition, when it is 500 mm/sec or less, the powder may sufficiently adhere to the photosoftening compound-containing layer, and a desired appearance such as mirror tone or pearl tone in the finally formed gloss image may be clarified.

Further, in the rubbing step, the contact width of the rubbing portion of the rubbing member to the surface of the photosoftening compound-containing layer is not particularly limited. From the viewpoint of the desired orientation of the powder adhering to the surface of the photosoftening compound-containing layer and the transportability of the recording medium, the thickness is preferably in the range of 1 to 200 mm. When it is 1 mm or more, when the rubbed portion moves along the surface of the photosoftening compound-containing layer, variation in the direction of the powder may be suppressed and the orientation of the powder adhering to the photosoftening compound-containing layer may be sufficiently controlled. When it is 200 mm or less, the recording medium may be transported stably and easily. The “contact width” refers to the length in the moving direction of the rubbing portion of the rubbing member with respect to the photosoftening compound-containing layer.

In addition, when pressing is given with rubbing, the pressing force is not particularly limited. It is preferably in the range of 1 to 30 kPa with respect to the surface of the photosoftening compound-containing layer. When it is 1 kPa or more, the adhesion strength of the powder to the photosoftening compound-containing layer may be sufficiently obtained. When the pressure is 30 kPa or less, the photosoftening compound-containing layer formed on the recording medium may be stably held.

The rubbing means used in the rubbing step is not particularly limited, and a known device may be used. As illustrated in FIG. 1 to FIG. 3, the rubbing member 30 as the rubbing means according to one aspect of the present invention is provided after the powder supply device (powder supply means) 10 or after the light irradiation device (light irradiation means) 20-1 or 20-2 with respect to the conveyance direction of the recording medium. The arrangement order of these devices is appropriately determined according to the order in which each step is performed.

The rubbing member provided in the rubbing means may be, for example, a rotating member as indicated in FIG. 1 to FIG. 3. It may be a reciprocating member or a non-rotating member such as a fixed member. More specifically, the rubbing member may be a member movable in a horizontal direction in contact with the surface of the photosoftening compound-containing layer having a horizontal surface, relative to the surface. It may be a rotatable roller (rotating roller) in contact with the surface of the photosoftening compound-containing layer. Among them, from the viewpoint of work efficiency, the rubbing member is preferably a rotating member, and more preferably a rotatable roller (rotating roller).

When a rotating member (in particular, a rotating roller) is used as the rubbing member, the rotational speed is not particularly limited.

It is preferable that the rubbing member has a surface movable relative to the surface of the photosoftening compound-containing layer while pressing the photosoftening compound-containing layer. When pressing is performed by the rubbing member, for example, the pressing may be performed by pressing the recording medium being transported (the recording medium on which the photosoftening compound-containing layer is formed) with the fixed rubbing member. The pressing may be performed by rubbing with a roller that rotates in the same direction as the conveyance direction of the recording medium and rotates at a speed slower than the conveyance speed of the recording medium. It may be performed by rubbing with a roller rotating in a direction opposite to the conveyance direction of the recording medium. Further, pressing may be performed by rubbing with a rotatable roller disposed in a direction in which the rotation axis is oblique to the recording medium conveyance direction. Alternatively, pressing may be performed by rubbing with a member reciprocating on the surface of the photosoftening compound-containing layer.

Therefore, it is preferable that the rubbing member is configured to be movable in a direction different from the recording medium while pressing the surface of the photosoftening compound-containing layer.

Moreover, it is preferable that the said rubbing member has a softness. The softness of the rubbing member is, for example, preferably such softness that the surface of the rubbing member is deformed to a degree capable of following the shape of the surface of the photosoftening compound-containing layer at the time of rubbing. That is, it is preferable that the rubbing member have a deformation followability. As a rubbing member which has such pliability, although a sponge and a brush are mentioned, for example, it is not restricted to these.

### (7) Other Steps

In the image forming method of the present invention, in addition to the powder supply step and the light irradiation step and the rubbing step optionally performed, other steps such as a photosoftening compound-containing layer forming step, a powder removing step, an additional printing step may be included.

### (7.1) Photosoftening Compound-Containing Layer Forming Step

The image forming method of the present invention may further include a photosoftening compound-containing layer forming step before the powder supply step and the light irradiation step.

In the photosoftening compound-containing layer forming step, the photosoftening compound-containing layer is formed on the recording medium. The method of forming the photosoftening compound-containing layer on the recording medium is not particularly limited. For example, it is formed by applying a solution obtained by dissolving a light-softening compound, a resin and optionally other components (e.g., a colorant) in a suitable solvent on the surface of a recording medium and drying it. In this case, the photosoftening compound-containing layer may be coated by generally used methods such as gravure coating, roll coating, blade coating, extrusion coating, dip coating, or spin coating.

The photosoftening compound-containing layer may be an image printed on a recording medium by a printing method such as an ink-jet method or an electrophotographic method. The formation of the image by the ink-jet method and the electrophotographic method may be performed by each of known image forming apparatuses.

From the viewpoint of easily obtaining the effects of the present invention, the photosoftening compound-containing layer is preferably an image formed by electrophotography. In the electrophotographic method, toner particles are attached to an electrostatic latent image pattern on the surface of a photoreceptor to form a toner image, and the toner image is transferred to a recording medium such as paper. Here, toner particles that form a toner image generally contain a thermoplastic resin as a binder resin. Therefore, the image (toner image) formed by the electrophotographic method is likely to be softened or melted by the light irradiated in the light irradiation step, and therefore, it is considered that the effects of the present invention can be more remarkably exhibited.

Further, in the image forming method of the present invention, the photosoftening compound-containing layer may be an image (unfixed image) before being fixed on the recording medium, or it may be a fixed image (fixed image). From the viewpoint of easily adhering powder on the surface of the photosoftening compound-containing layer and forming an image having sufficient glossiness, the photosoftening compound-containing layer is preferably a fixed image fixed on a recording medium. That is, the image forming method of the present invention preferably further includes a fixed image forming step before the powder supply step and the light irradiation step. The surface of the fixed image is uniformly smoothed, so that the powder may be prevented from being buried in the photosoftening compound-containing layer, and an image with high gloss may be formed. In addition, since powder may adhere to the surface of the photosoftening compound-containing layer while suppressing powder burial, there is no need to use a large amount of powder, which is preferable from the viewpoint of economy.

The fixed image forming step may be performed by a known fixed image forming apparatus, in particular, an image forming apparatus using an electrophotographic method. As an example of the fixed image forming method, a method may be adopted in which heat and pressure are applied by the fixing means to the recording medium to which the toner image has been transferred, and the toner image on the recording medium is fixed on the recording medium. By performing the image forming method according to an embodiment of the present invention, the toner image is formed as a photosoftening compound-containing layer, as described above, the powder is prevented from being buried in the photosoftening compound-containing layer. Thereby, it is possible to form an image with excellent gloss.

### (7.2) Powder Removing Step

The image forming method of the present invention may further include a powder removing step after the powder supply step and the light irradiation step, or after the rubbing step performed as needed. In the powder removing step, the powder not adhering to the photosoftening compound-containing layer is removed from the recording medium. At this time, the powder removed from the recording medium may be recovered and reused. That is, the image forming method of the present invention may further contain a powder recovering step to recover the powder that did not adhere to the photosoftening compound-containing layer after the powder supply step and the light irradiation step, or after the rubbing step performed as necessary. As described above, it is preferable to recover excess powder that has not been used for decoration from the viewpoint of economy and reducing the environmental load.

The method for removing or recovering the powder is not particularly limited, and may be performed by a known method. Examples thereof are: a method of scraping with a member such as a brush or a brush; a method of removing with an adhesive member such as an adhesive tape; and a method of sucking with a known device such as a powder collector capable of sucking or adsorbing powder. Thus, as the powder removing device (member) or the powder recovering device (member) for performing the powder removing step or the powder recovering step, as described above, it is possible to use a member such as a brush, an adhesive member having adhesiveness to powder, and a dust collector having a suction member for sucking powder. When the powder is a magnetic powder, a powder collector having a magnet member may be used.

### (7.3) Additional Printing Step

The image forming method of the present invention may further include an additional printing step after the powder supply step and the light irradiation step, or after the rubbing step and/or the powder removing step performed as needed. In the additional printing step, an image is further formed on a recording medium having a powder-adhered photosoftening compound-containing layer (that is, a gloss image that has already been decorated). The additional printing method is not particularly limited, and a known method may be used. For example, a printing method such as an ink-jet method or an electrophotographic method may be used. In addition, a known device may be used as a printing device for performing the additional printing step. From the viewpoint of further improving the added value of the printed matter, it is preferable to further carry out the additional printing step.

### (7.4) Fixing Step

In the image forming method of the present invention, after the powder supply step and the light irradiation step, or after the rubbing step, the powder removing step and/or the additional printing step which are performed as necessary, it is also preferable to contain a fixing step when needed. For example, when the photosoftening compound is an azobenzene derivative, after fixing or softening by UV irradiation, a fixing device is required to apply heat or visible light to re-cure. On the other hand, since the triphenylimidazole polymer is naturally cured by stopping the light irradiation, a fixing device is not necessary. The fixing step is not particularly limited, and may be performed by a known fixing image forming apparatus, in particular, an image forming apparatus using an electrophotographic method. As an example of the fixed image forming method, a method may be adopted in which heat and pressure are applied by the fixing means to the recording medium to which the toner image has been transferred, and the toner image on the recording medium is fixed on the recording medium. By performing the image forming method according to an embodiment of the present invention, the toner image is formed as a photosoftening compound-containing layer, as described above, the powder is prevented from being buried in the photosoftening compound-containing layer. Thereby, it is possible to form an image with excellent gloss.

Further, it is preferable that the fixing step is performed by light irradiation. It is possible to perform light irradiation by using the above-mentioned method and apparatus, and the irradiation conditions may be adjusted suitably.

### (8) Order of Each Step

The image forming method of the present invention includes a powder supply step and a light irradiation step, and the order of these steps is not particularly limited. That is, the light irradiation step may be performed before or after the powder supply step.

### (8.1) Image Forming Method of Performing Light Irradiation Step After Powder Supply Step

In the image forming method of the present invention, the light irradiation step may be performed after the powder supply step. When the powder is supplied onto the photosoftening compound-containing layer after the photosoftening compound-containing layer is melted or softened by the light irradiation step, during the period from melting or softening of the photosoftening compound-containing layer to supply of the powder, the photosoftening compound-containing layer may be cured, and the powder may not easily adhere to the photosoftening compound-containing layer. Therefore, when the light irradiation step is performed first, it is necessary to relatively increase the amount of light irradiated to the photosoftening compound-containing layer. On the other hand, by performing the powder supplying step first, light is irradiated in a state where powder is present on the photosoftening compound-containing layer, and the photosoftening compound-containing layer is melted or softened, so that the melting or softening light quantity may be minimized Moreover, since the said powder is also heated by light-irradiating with respect to the powder on a light melting or a softening compound containing layer, there also exists an advantage that resin may be fused or softened efficiently. Furthermore, since the decorated portion may be formed even if the time from the powder supply step to the light irradiation step is long, there is no need to increase the process speed. Therefore, from the viewpoint of energy efficiency, it is preferable to perform each step in the above order.

### (8.2) Image Forming Method of Performing Powder Supply Step After Light Irradiation Step

In the image forming method of the present invention, the powder supply step may be performed after the light irradiation step.

When light is irradiated in a state where the powder is attached on the photosoftening compound-containing layer, the heat generated by the light irradiation may be diffused by the powder. On the other hand, by performing the light irradiation step first, such thermal diffusion can be suppressed, and the end of the portion to which the gloss is to be provided may be formed more clearly. That is, the edge of the portion to which the gloss is to be applied can be formed sharply. In addition, since the powder is not irradiated with light, for example, even a powder with low light resistance may be used, and various powders may be used. Therefore, it is possible to form an image with more various textures.

### (8.3) Preferred Embodiment

As described above, in the image forming method of the present invention, it is preferable to further carry out the rubbing step after the powder supply step and the light irradiation step. Therefore, a preferable embodiment of the image forming method according to the present invention includes performing a powder supply step, a light irradiation step, and a rubbing step in this order. Further, another preferable embodiment of the image forming method of the present invention includes performing a light irradiation step, a powder supply step, and a rubbing step in this order.

In addition, as described above, it is preferable to perform the photosoftening compound-containing layer forming step before these steps, and the photosoftening compound-containing layer forming step is preferably a fixed image forming step. That is, a preferable embodiment of the image forming method of the present invention includes performing a fixed image forming step, a powder supply step, a light irradiation step, and a rubbing step in this order. Further, another preferable embodiment of the image forming method of the present invention includes performing a fixed image forming step, a light irradiation step, a powder supply step, and a rubbing step in this order.

Furthermore, as described above, after the above steps, a powder removing step and an additional printing step and/or a fixing step may be further performed.

### (9) Image Forming Apparatus

The image forming apparatus for carrying out the image forming method of the present invention preferably comprises a powder supply means for supplying powder onto a photosoftening compound-containing layer formed on a recording medium which is melted or softened by light, and a light irradiation means for irradiating light to the aforesaid photosoftening compound-containing layer. Further, it is preferable that the above-mentioned image forming apparatus further comprises the following means as needed: a rubbing means for rubbing the photosoftening compound-containing layer (the photosoftening compound-containing layer to which the powder is attached) to which the powder is supplied; a powder removing means (preferably, powder recovery means) for removing from the recording medium the powder not adhering to the photosoftening compound-containing layer; an image forming means (additional printing means) for forming an image on a recording medium having a photosoftening compound-containing layer (that is, a gloss image already decorated) to which the powder is attached; and a means for fixing the image. These rubbing means, powder removing means (preferably, powder recovery means), image forming means (additional printing means) and fixing means may be provided in the image forming apparatus singly or in combination of two or more. Among them, it is preferable that the image forming apparatus further includes the above-described image forming means (additional printing means) from the viewpoint of enhancing the productivity of an image having high added value.

The specific description of the above-mentioned powder supply means, light irradiation means, rubbing means, powder removing means (powder recovery means), image forming means (additional printing means), and fixing means are described in the description of the above steps.

The image forming device described above may be provided in the same enclosure as the enclosure where the fixed image forming device described above is provided, or it may be provided outside the enclosure where the fixed image forming device is provided.

Although the embodiments of the present invention have been described and illustrated in detail, the disclosed embodiments are made for purpose of illustration and example only and not limitation. The scope of the present invention should be interpreted by terms of the appended claims

### EXAMPLES

Hereinafter, the present invention will be specifically described by way of examples, but the present invention is not limited thereto. In addition, although the term “part” or “%” is used in an Example, unless otherwise indicated, it represents “mass part” or “mass %”.

### (Preparation of Toner)

### (Synthesis of Azobenzene Derivative 1)

After adding 75 mL of 2.4 N hydrochloric acid to 4-aminophenol (6.54 g, 60 mmol), while cooling and stirring at 0° C., a solution of sodium nitrite (4.98 g, 72 mmol) dissolved in 6 mL of distilled water was added ant the mixture was stirred at 0° C. for 60 minutes. A mixed solution of o-cresol (6.48 g, 60 mmol) and 24 mL of a 20% aqueous solution of sodium hydroxide was added to this solution and stirred for 20 hours. The deposited precipitate was filtered off and the solid was washed with water. The resulting solid was purified by silica gel column chromatography using a mixed solution of ethyl acetate and hexane as a developing solvent, and recrystallized with a mixed solvent of acetone and hexane to obtain intermediate A (see the structure in the above reaction scheme A). To this intermediate A (2.28 g, 10 mmol), 100 mL of DMF, 1-bromohexane (9.9 g, 60 mmol) and potassium carbonate (6.9 g, 50 mmol) were added, and stirred at 80° C. for 2 hours. Stirring was continued at room temperature for 20 hours. The solvent was evaporated away under reduced pressure, and the residue was extracted with ethyl acetate. The organic layer was washed with saturated aqueous solution of sodium chloride and then dried over anhydrous magnesium sulfate. After filtration, the solvent was distilled off under reduced pressure, and the obtained solid was purified by silica gel column chromatography using a mixture of ethyl acetate and hexane as a developing solvent. Thus, the following azobenzene derivative 1 was obtained.

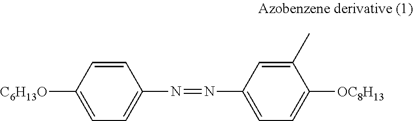

### (Preparation of Styrene-Acrylic Resin Particle Dispersion Liquid 1)

201 mass parts of styrene, 117 mass parts of n-butyl acrylate and 18.3 mass parts of methacrylic acid were mixed, and this monomer mixture was heated to 80° C. while stirring. Then, 172 mass parts of behenyl behenate were gradually added to the mixture and dissolved.

Then, a surfactant aqueous solution prepared by dissolving 3 mass parts of dodecylbenzenesulfonic acid which is an anionic surfactant in 1182 mass parts of pure water was heated to 80° C. The above monomer mixture was added thereto, and high speed stirring was performed to prepare a monomer dispersion liquid.

To a polymerization device equipped with a stirring device, a cooling pipe, a temperature sensor, and a nitrogen introduction pipe were placed 867.5 mass parts of pure water, and the internal temperature was brought to 80° C. while stirring under a nitrogen stream. The monomer dispersion was charged into the polymerization apparatus, and a polymerization initiator aqueous solution in which 8.55 mass parts of potassium persulfate were dissolved in 162.5 mass parts of pure water was further charged.

After the polymerization initiator aqueous solution was charged, 5.2 mass parts of n-octylmercaptan were added over 35 minutes, and polymerization was further performed at 80° C. for 2 hours. Next, a polymerization initiator aqueous solution in which 9.96 mass parts of potassium persulfate were dissolved in 189.3 mass parts of pure water was added. Then, a monomer solution mixed with 366.1 mass parts of styrene, 179.1 mass parts of n-butyl acrylate, and 7.2 mass parts of octyl mercaptan was dropped over 1 hour. After the monomer solution was dropped, the polymerization treatment was continued for 2 hours and then cooled to room temperature (25° C.) to prepare a dispersion liquid 1 containing styrene-acrylic resin particles as binder resin particles.

### <Preparation of Toner 1>

### (Preparation of Azobenzene Derivative Particle Dispersion Liquid 1)

80 mass parts of dichloromethane and 20 mass parts of the azobenzene derivative 120 were mixed and heated while heating at 50° C. to obtain a liquid containing the azobenzene derivative 1. To 100 mass parts of this solution, a mixed solution of 99.5 mass parts of distilled water warmed to 50° C. and 0.5 mass parts of a 20 mass % of aqueous solution of sodium dodecylbenzene sulfonate was added. Thereafter, the mixture was stirred at 16000 rpm for 20 minutes and emulsified by a homogenizer (manufactured by Beiersdorf) equipped with a shaft generator 18F to obtain an azobenzene derivative emulsion 1. The resulting azobenzene derivative emulsion 1 was charged into a separable flask, and heated and stirred at 40° C. for 90 minutes while sending nitrogen into the gas phase to remove the organic solvent, thereby obtaining the azobenzene derivative particle dispersion liquid 1. The particle diameter of the azobenzene derivative particles in the azobenzene derivative particle dispersion liquid was measured using an electrophoretic light scattering photometer “ELS-800” (manufactured by Otsuka Electronics Co., Ltd.). The mass average particle diameter was 145 nm.

### (Aggregation and Fusion)

574 mass parts in terms of solid content of the aforesaid styrene-acrylic resin particle dispersion liquid 1, 216 mass parts in terms of solid content of the azobenzene derivative particle dispersion liquid 1, and 900 mass parts of ion-exchanged water were charged into a reactor equipped with a stirrer, a temperature sensor, and a cooling pipe. The temperature in the vessel was maintained at 30° C. and the pH was adjusted to 10 by adding 5 mol/L aqueous sodium hydroxide solution.

Next, an aqueous solution in which 2 mass parts of magnesium chloride hexahydrate was dissolved in 1000 mass parts of ion-exchanged water was added dropwise over 10 minutes with stirring. The temperature was raised, the system was heated to 70° C. for 60 minutes, and the particle growth reaction was continued while maintaining 70° C. In this state, the particle size of the associated particles was measured with “Multisizer 3” (manufactured by Beckman Coulter, Inc.), and when the median diameter (d50) on a volume basis became 6.5 μm, In this state, the particle size of the associated particles is measured with “Multisizer 3” (manufactured by Beckman Coulter, Inc.), and when the median diameter (d50) on a volume basis becomes 6.5 μm, an aqueous solution in which 190 mass parts of sodium chloride was dissolved in 760 mass parts of ion-exchange water was added to stop particle growth. After stirring at 70° C. for 1 hour, the temperature was further raised, and by heating and stirring at 75° C., fusion of particles was advanced. Thereafter, the dispersion was cooled to 30° C. to obtain a dispersion liquid of toner particles.

The dispersion liquid of toner particles obtained above was subjected to solid-liquid separation with a centrifuge to form a wet cake of toner particles. The wet cake was washed with ion-exchanged water at 35° C. until the electric conductivity of the filtrate reaches 5 μS/cm in the above-mentioned centrifuge, and then transferred to “Flush jet dryer (manufactured by Seishin Co., Ltd.)”. The substance was dried until the water content of 0.5 mass %. Thus toner particles were prepared.

To the obtained toner particles were added 1 mass % of hydrophobic silica (number average primary particle size: 12 nm) and 0.3 mass % of hydrophobic titania (number average primary particle size: 20 nm), and the mixture was mixed with Henschel mixer (registered trademark) to prepare a toner 1.

The volume-based median diameter (d₅₀) of the toner 1 obtained was measured using “Coulter Counter 3 (manufactured by Beckman Coulter, Inc.)” and found to be 7.2 μm.

### <Preparation of Toner 2>

### (Synthesis of Azobenzene Derivative 2)

### <Synthesis of Azobenzene Derivative Monomer 1>

In a 300 mL of three-necked flask, 6.44 g (0.933 mol) of sodium nitrite was dissolved in 20 mL of water and cooled until the internal temperature reached 0° C. To this, 5 g (0.047 mol) of p-toluidine and 23 g of 0.2 N aqueous hydrochloric acid were slowly added dropwise at an internal temperature of 5° C. or less. After dropping, the mixture was stirred for 30 minutes while maintaining the internal temperature. In the resulting solution, a solution of 5.71 g (0.06 mol) of phenol, 2.43 g (0.06 mol) of sodium hydroxide and 6.43 g (0.06 mol) of sodium carbonate dissolved in 20 mL of water was slowly added dropwise while keeping an internal temperature of 5° C. or less. Thus yellow crystals were precipitated. After completion of the dropwise addition, the mixture was stirred for 30 minutes while maintaining the internal temperature, then the product was filtered, and washed with cold water to obtain orange crystals. This was dried and then purified on a silica gel column (ethyl acetate/heptane=1/4) to obtain 9.7 g (yield 97.9%) of a target compound 1 (4-(p-tolyldiazenyl)phenol).

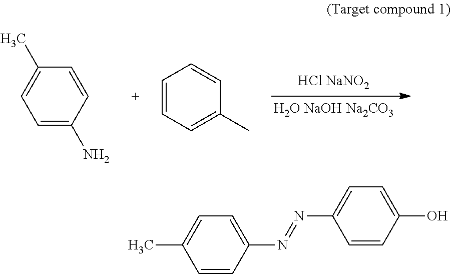

5 g (0.024 mol) of the target compound 1 (4-(p-tolyldiazenyl)phenol) thus obtained was dissolved in 25 mL of dimethylformamide (DMF) in 200 mL of four-necked flask. To this, 4.88 g (0.035 mol) of potassium carbonate was added, and the mixture was stirred for 30 minutes while maintaining at 30° C. To this, 10.2 mg (0.06 mmol) of potassium iodide and 3.54 g (0.026 mol) of 6-chloro-1-hexanol were added and reacted at 110° C. for 3 hours. The reaction mixture was cooled to room temperature, and added to 650 g of ice and filtered. The crystals were dispersed in 400 mL water, washed by stirring overnight, filtered and dried. The product was recrystallized to obtain 6.41 g (yield 87.1%) of orange crystals (target compound 2; 6-(4-(p-tolyldiazenyl)phenoxy)hexane-1-ol).

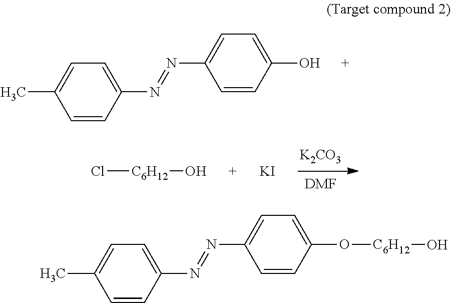

3 g (0.001 mol) of the target compound 2 (6-(4-(p-tolyldiazenyl)phenoxy)hexan-1-ol) thus obtained, 1.34 mL (0.001 mol) of triethylamine and 30 mL of dichloromethane were placed in a 100 mL four-necked flask. At this time, the raw materials were in a dispersed state. While maintaining the internal temperature at 0° C., a solution of 1.04 g (0.011 mol) of acrylic acid chloride dissolved in 10 mL of dichloromethane was added dropwise while maintaining the internal temperature at 0-5° C. As it was dropped, the raw materials dissolved. After completion of the dropwise addition, the reaction solution was returned to room temperature and stirred for 5 hours. After completion of the reaction, dichloromethane was concentrated and removed, and the residue was dissolved in ethyl acetate, washed with dilute hydrochloric acid, aqueous sodium hydrogen carbonate solution and saturated aqueous solution of sodium chloride, and the organic layer was dried over magnesium sulfate and concentrated. The obtained orange crystals were purified with a silica gel column (ethyl acetate/heptane=1/5) to obtain 2.87 g (51.4%) of an azobenzene derivative monomer 1.

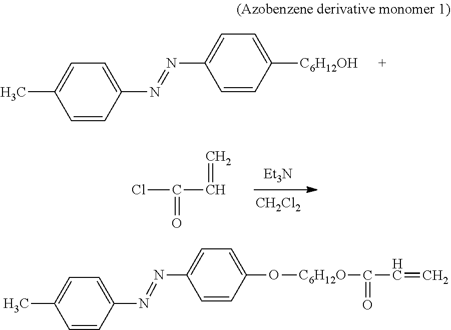

### <Synthesis of Azobenzene Derivative 2>

In a 100 mL four-necked flask, 1.5 g (4.096 mmol) of the azobenzene derivative monomer 1 obtained above, 5 mg (0.023 mmol) of 4-cyanopentanoic acid dithiobenzoate and 1 mL (0.006 mmol) of 2,2′-Azobis(isobutyronitrile) (AIBN) were dissolved in 4 mL of anisole. Then, after obtaining argon gas atmosphere by freeze degassing, the temperature was raised to 75° C. and polymerization was performed by stirring for 48 hours. After 40 mL of methanol was gradually dropped to the polymer solution, tetrahydrofuran (THF) was added to remove unreacted azobenzene derivative monomer 1. The separated polymer solution was dried in a vacuum drying oven at 40° C. for 24 hours to obtain an azobenzene derivative 2. The number average molecular weight Mn of the azobenzene derivative 2 was 9600. Further, the particle diameter of the azobenzene derivative particles in the azobenzene derivative particle dispersion liquid was measured using an electrophoretic light scattering photometer “ELS-800” (manufactured by Otsuka Electronics Co., Ltd.) in the same manner as the azobenzene derivative particle dispersion liquid 1 described above. The mass average particle diameter was 145 nm.

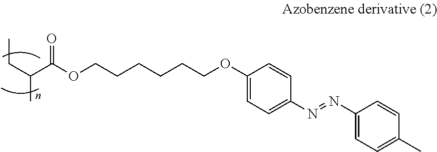

Subsequently, Toner 2 was prepared in the same manner as Preparation of the toner 1, except that the azobenzene derivative 2 obtained above was used instead of the azobenzene derivative 1.

### <Preparation of Toner 3>

### (Preparation of Styrene-Acrylic Resin Particle Dispersion Liquid 1 Containing Styrene-Acrylic Resin 1)

### (1) First Stage Polymerization

Into a reaction vessel equipped with a stirrer, a temperature sensor, a cooling tube, and a nitrogen introducing device, a solution of 8 mass parts of sodium dodecyl sulfate dissolved in 3,000 mass parts of ion-exchanged water was charged. While stirring at a stirring speed of 230 rpm under a nitrogen flow, the inner temperature of the reaction vessel was raised to 80° C. After raising the temperature, a solution of 10 mass parts of potassium persulfate dissolved in 200 mass parts of ion-exchanged water was added thereto, and the liquid temperature was raised again to 80° C. The following polymerizable monomer solution was added dropwise to this solution over 1 hour.

Styrene: 480 mass parts

n-Butyl acrylate: 250 mass parts

Methacrylic acid: 68.0 mass parts

n-Octyl 3-mercaptopropionate: 16.0 mass parts

After dropping the monomer mixture, the reaction system was heated and stirred at 80° C. for 2 hours to carry out the polymerization. Thus, a styrene-acrylic resin particle dispersion liquid (1A) containing styrene-acrylic resin particles (la) was prepared.

### (2) Second Stage Polymerization

Into a reaction vessel equipped with a stirrer, a temperature sensor, a cooling tube, and a nitrogen introducing device, a solution of 7 mass parts of sodium polyoxyethylene (2) dodecyl ether sulfate dissolved in 800 mass parts of ion-exchanged water was charged. The solution was heated to 98° C. Then, the following polymerizable monomer solution dissolved at 90° C. was added.

Styrene-acrylic resin particle dispersion liquid (1A) prepared above:

260 mass parts

Styrene: 245 mass parts

n-Butyl acrylate: 120 mass parts

n-Octyl 3-mercaptopropionate: 1.5 mass parts

Paraffin wax “HNP-11” (produced by Nippon Seiro Co. Ltd):
67 mass parts

The reaction system was mixed and dispersed for 1 hour by using a mechanical disperser with a circulation route “CLEARMIX” (manufactured by M Technique Co. Ltd.) so that a dispersion liquid containing emulsion particles (oil particles) was prepared.

Then, an initiator solution of 6 mass parts of potassium persulfate dissolved in 200 mass parts of ion-exchanged water was added to the dispersion liquid, and the system was heated and stirred at 82° C. for 1 hour to carry out polymerization. Thereby a styrene-acrylic resin particle dispersion liquid (1B) containing styrene-acrylic resin particles (1b) was prepared.

### (3) Third Stage Polymerization

To the styrene-acrylic resin particle dispersion liquid (1B) as described above was added a solution of 11 mass parts of potassium persulfate dissolved in 400 mass parts of ion-exchanged water. The following polymerizable monomer solution was added to this at a temperature condition of 82° C. over 1 hour.

Styrene: 435 mass parts

n-Butyl acrylate: 130 mass parts

Methacrylic acid: 33 mass parts

n-Octyl 3-mercaptopropionate: 8 mass parts

After completion of the dropwise addition, polymerization was carried out by heating and stirring at 82° C. for 2 hours, followed by cooling to 28° C., whereby a styrene-acrylic resin particle dispersion liquid 1 containing styrene-acrylic resin 1 was obtained. The glass transition temperature of this styrene-acrylic resin 1 was measured to be 45° C.

### (Preparation of Dispersion Liquid of Polymer Compound (A) Having a Branched Chain of Hexaarylimidazole Group)

80 mass parts of dichloromethane and 20 mass parts of the following compound (A) were mixed and heated while heating at 50° C. to obtain a solution containing the compound A. In 100 parts by mass of the obtained solution, a mixed solution of 99.5 mass parts of distilled water warmed to 50° C. and 0.5 mass parts of a 20 mass % aqueous solution of sodium dodecylbenzene sulfonate was added. Thereafter, the mixture was stirred at 16000 rpm for 20 minutes and emulsified by a homogenizer (manufactured by Beiersdorf) equipped with a shaft generator 18F to obtain an emulsion of the compound (A).

The resulting emulsion of the compound (A) was charged into a separable flask, and heated and stirred at 40° C. for 90 minutes while sending nitrogen into the gas phase to remove the organic solvent, thereby obtaining the compound (A) particle dispersion liquid. The particle diameter of the compound (A) particles in the compound (A) particle dispersion liquid was measured using an electrophoretic light scattering photometer “EL S-800” (manufactured by Otsuka Electronics Co., Ltd.). The mass average particle diameter was 172 nm.

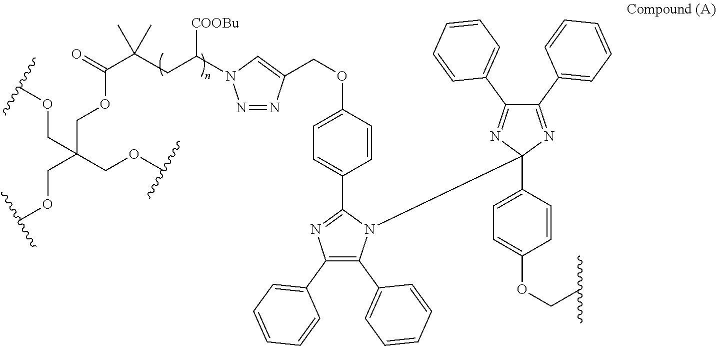

### (Aggregation and Fusion)

214 mass parts in terms of solid content of the aforesaid styrene-acrylic resin particle dispersion liquid 1, 576 mass parts in terms of solid content of the compound (A) particle dispersion liquid 1, and 900 mass parts of ion-exchanged water were charged into a reactor equipped with a stirrer, a temperature sensor, and a cooling pipe. The temperature in the vessel was maintained at 30° C. and the pH was adjusted to 10 by adding 5 mol/L aqueous sodium hydroxide solution.

Next, an aqueous solution in which 2 mass parts of magnesium chloride hexahydrate was dissolved in 1000 mass parts of ion-exchanged water was added dropwise over 10 minutes with stirring. The temperature was raised, the system was heated to 70° C. for 60 minutes, and the particle growth reaction was continued while maintaining 70° C. In this state, the particle size of the associated particles was measured with “Multisizer 3” (manufactured by Beckman Coulter, Inc.), and when the median diameter (d50) on a volume basis became 6.5 μm, In this state, the particle size of the associated particles is measured with “Multisizer 3” (manufactured by Beckman Coulter, Inc.), and when the median diameter (d50) on a volume basis becomes 6.5 μm, an aqueous solution in which 190 mass parts of sodium chloride was dissolved in 760 mass parts of ion-exchange water was added to stop particle growth. After stirring at 70° C. for 1 hour, the temperature was further raised, and by heating and stirring at 75° C., fusion of particles was advanced. Thereafter, the dispersion was cooled to 30° C. to obtain a dispersion liquid of toner particles.

The dispersion liquid of toner particles obtained above was subjected to solid-liquid separation with a centrifuge to form a wet cake of toner particles. The wet cake was washed with ion-exchanged water at 35° C. until the electric conductivity of the filtrate reaches 5 μS/cm in the above-mentioned centrifuge, and then transferred to “Flush jet dryer (manufactured by Seishin Co., Ltd.)”. The substance was dried until the water content of 0.5 mass %. Thus toner particles were prepared.

To the obtained toner particles were added 1 mass % of hydrophobic silica (number average primary particle size: 12 nm) and 0.3 mass % of hydrophobic titania (number average primary particle size: 20 nm), and the mixture was mixed with Henschel mixer (registered trademark) to prepare a toner 3.

The volume-based median diameter (d₅₀) of the toner 3 obtained was measured using “Coulter Counter 3 (manufactured by Beckman Coulter, Inc.)” and found to be 9.7 μm. The glass transition temperature (Tg) of the toner 3 was 45° C.

### <Preparation of Toner 4>

A toner 4 containing no azobenzene derivative was produced in the same manner as preparation of the toner 1 except that the azobenzene derivative 1 was not used.

### Example 1

A fixed image of 2 cm×2 cm square patch was obtained using the toner 1 by using Konica Minolta J Paper A4 as a recording medium and a modified AccurioPress C2060 (made by Konica Minolta, Inc.) as an output machine

The fixed image was set in the apparatus indicated in FIG. 1, and while moving the fixed image to the right side, METASHINE 2025 PS (made by Nippon Sheet Glass Co., Ltd., shape: flake-like, thickness: 1 μm, average particle diameter 25 μm, component: silver/glass, denoted as 2025 PS in Table I) was scattered. Then, light of 9 J/cm² was irradiated by a light irradiation device 20-1 (light source: LED light source with an emission wavelength of 365 nm±10 nm), and rubbed with a sponge roller. Further, after irradiation with light of a light quantity of 20 J/cm² with a light irradiation device 20-2 (light source: LED light source with emission wavelength of 505 nm±10 nm), the powder was removed by a brush. The obtained image was a pearl tone image. Similarly, when light with a light quantity of 10 J/cm² was irradiated, an image having intermediate tone between pearl tone and glitter tone was obtained, and when light with 11 J/cm² was irradiated, a glitter tone image was obtained. As described above, it was possible to control from pearl tone to glitter tone by changing the light irradiation energy.

### Example 2

A plurality of portions with different decoration states were produced on one image in one pass. A fixed image of a solid image of the toner 1 was obtained on almost the entire surface (19 cm×27 cm) of A4 paper by using Konica Minolta J Paper A4 as a recording medium and a modified AccurioPress C2060 as the output machine.

The fixed image was set in the apparatus indicated in FIG. 1, and while moving the fixed image to the right side, METASHINE 2025 PS was scattered. Next, when passing through the light irradiation position, the light quantity was changed to 9 J/cm², 10 J/cm² and 11 J/cm² by the light irradiation device 20-1 (light source: LED light source with light emission wavelength 365 nm±10 nm). Then, the irradiated image was conveyed to the rubbing position and rubbed with a sponge roller. Further, after irradiation with light of a light quantity of 20 J/cm² with a light irradiation device 20-2 (light source: LED light source with emission wavelength of 505 nm±10 nm), the powder was removed by a brush. In the obtained image, portions different in three steps of the irradiation light amount was created, and when the image was observed, it was possible to control from pearl tone to glitter tone.

### Example 3

A fixed image of 2 cm×2 cm square patch was obtained using the toner 1 by using Konica Minolta J Paper A4 as a recording medium and a modified AccurioPress C2060 (made by Konica Minolta, Inc.) as an output machine

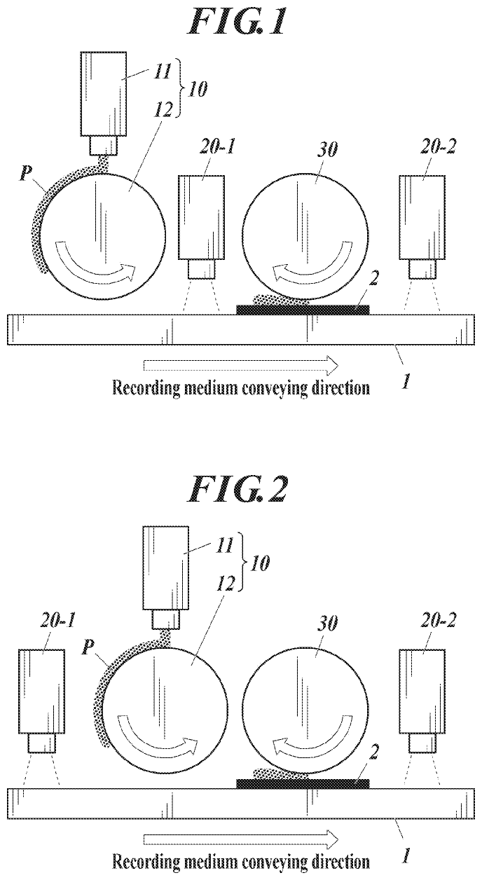

The fixed image was set in the apparatus indicated in FIG. 2 and irradiated with light by a light irradiation device 20-1 (light source: LED light source with an emission wavelength of 365 nm±10 nm) to melt or soften the toner. Then, METASHINE 2025 PS (made by Nippon Sheet Glass Co., Ltd.) was scattered. Then, the scattered image was conveyed to the rubbing position and rubbed with a sponge roller. Further, after irradiation with light of a light quantity of 20 J/cm² with a light irradiation device 20-2 (light source: LED light source with emission wavelength of 505 nm±10 nm), the powder was removed by a brush. The obtained image was a pearl tone image. Similarly, when light with a light quantity of 10 J/cm² was irradiated, an image having intermediate tone between pearl tone and glitter tone was obtained, and when light with 11 J/cm² was irradiated, a glitter tone image was obtained. As described above, it was possible to control from pearl tone to glitter tone by changing the light irradiation energy.

### Example 4

Evaluation was carried out in the same manner as in Example 1 except that the toner 1 was changed to the toner 2. It was possible to control from pearl tone to glitter tone similarly to Example 1 by changing the light irradiation energy.

### Example 5

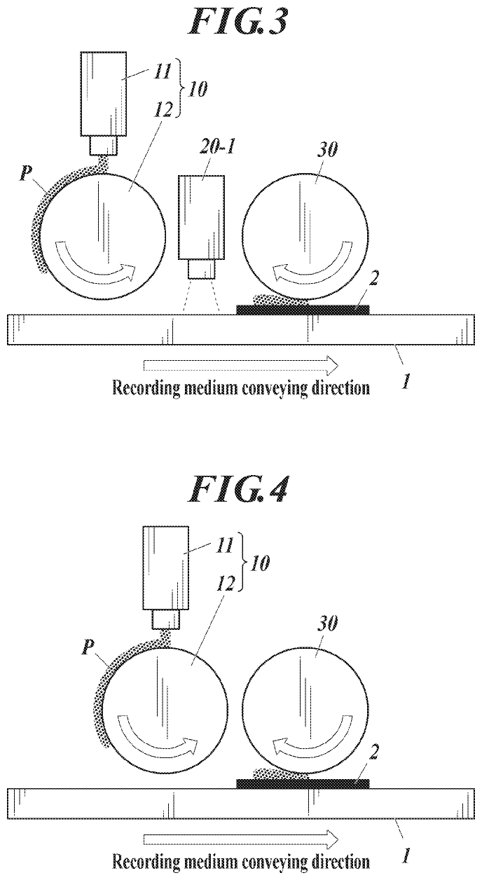

Evaluation was carried out in the same manner as in Example 1 except that the toner 1 was changed to the toner 3 and the apparatus indicated in FIG. 1 was changed to the apparatus shown indicated FIG. 3. It was possible to control from mirror tone to glitter tone similarly to Example 1 by changing the light irradiation energy.

### Example 6

Evaluation was carried out in the same manner as in Example 1 except that METASHINE 2025 PS (made by Nippon Sheet Glass Co., Ltd.) was changed to Matsumoto Microsphere F-35D (made by Matsumoto Yushi-Seiyaku Co., Ltd., a thermally expandable microcapsule having an average particle size of 5 to 50 μm, denoted as F-35D in Table I), and the light irradiation device 20-1 (light source: LED light source with an emission wavelength of 365 nm±10 nm) was used to emit light with a light amount of 10 J/cm². An embossed image was obtained.

### Example 7

When evaluation was carried out in the same manner as in Example 1, except that the J paper A4 manufactured by Konica Minolta Co., Ltd. was changed to a 57 μm thick biaxially oriented polypropylene (PP) film, it was possible to control from pearl tone to glitter tone by changing the light irradiation energy.

### Comparative Example 1

Evaluation was carried out in the same manner as in Example 1 except that the apparatus indicated in FIG. 1 was changed to an apparatus not having the light irradiation apparatus indicated in FIG. 4.

### Comparative Example 2

Evaluation was carried out in the same manner as in Example 1 except that the toner 1 in Example 1 was changed to the toner 4 containing no azobenzene derivative.

### «Evaluation»

### (Evaluation of Metallic Feeling)

Five experimenters evaluated whether they felt metallic feeling (mirror tone-pearl tone, glitter tone, or intermediate tone thereof) by visually observing the aforesaid images. Further, they observed the color of the aforesaid images. With respect to the case of Examples 6, the experimenters observed the state of the image surface in the same manner.

### (Fixation Rate of Metallic Gloss Image (Hiding Rate))

The obtained image was rubbed ten times by applying a pressure of 50 kPa with “JK Wiper (registered trademark)” (manufactured by Nippon Paper Industries Co., Ltd.) to make a deterioration test. The image after the deterioration test was photographed at a magnification of 100 times using a digital microscope VHX-6000 manufactured by Keyence Corporation, and a binarization process was performed using LUSEX-AP manufactured by Nireco. Subsequently, the hiding rate with respect to the powder supply area by powder was calculated. The peeling ratio in the evaluation of the fixability was calculated based on the following formula (a).

Peeling ratio between recording medium and powder=100−(Hiding ratio of powder supply area by powder after deterioration test/Hiding ratio of powder supply area by powder after rubbing process) Formula (a):

The case where the said peeling rate is 5% or more was made into pass. More preferably, it is 40% or more.

The configurations of the above examples and comparative examples, and the evaluation results are summarized in Table I.

TABLE I

| | | | | | | | | Hiding |
|---|---|---|---|---|---|---|---|---|
| | Toner | | Recording | Apparatus | Light irradiation energy | | | ratio |
| Level | No. | Powder | medium | No. | 9 J/cm² | 10 J/cm² | 11 J/cm² | (%) |
| Example 1 | 1 | 2025PS | J paper | FIG. 1 | Pearl | Intermediate | Glitter | 61 |
| | | | | | tone | tone | tone | |
| Example 2 | 1 | 2025PS | J paper | FIG. 1 | Pearl | intermediate | Glitter | 57 |
| | | | | | tone | tone | tone | |
| Example 3 | 1 | 2025PS | J paper | FIG. 2 | Pearl | intermediate | Glitter | 45 |
| | | | | | tone | tone | tone | |
| Example 4 | 2 | 2025PS | J paper | FIG. 1 | Pearl | Intermediate | Glitter | 65 |
| | | | | | tone | tone | tone | |
| Example 5 | 3 | 2025PS | J paper | FIG. 3 | Mirror | Intermediate | Glitter | 65 |
| | | | | | tone | tone | tone | |
| Example 6 | 1 | F-35D | J paper | FIG. 1 | — | Embossed | — | 49 |
| | | | | | | tone | | |
| Example 7 | 1 | 2025PS | PP film | FIG. 1 | Pearl | Intermediate | Glitter | 42 |
| | | | | | tone | tone | tone | |
| Comparative | 1 | 2025PS | J paper | FIG. 4 | — | — | — | 2 |
| Example 1 | | | | | | | | |
| Comparative | 4 | 2025PS | J paper | FIG. 1 | — | — | — | 1 |
| Example 2 | | | | | | | | |

From the results of Table I, it was confirmed that even if the same powder is used, it is possible to reproduce from the mirror tone-pearl tone to the glitter tone by changing the light irradiation amount according to the image forming method of the present invention. In addition, from Example 2, it was possible to achieve decorative expressions of different textures (i.e., from mirror-pearl tones to glitter tones) in the same image. Furthermore, it was possible to achieve similar decorative expressions (that is, from mirror tone-pearl tone to glitter tone) not only for paper media but also for recording media with low heat resistance such as plastic films.

Moreover, it was confirmed from Example 6 that the embossed decorative expression may also be realized by using the heat responsive material.

What is claimed is:

1. An image forming method for forming an image comprising a recording medium and a layer containing a photosoftening compound disposed thereon, the image forming method comprising the steps of:
supplying a powder for adhering the powder to the image; and
irradiating the image with light to melt or to soften the image.

2. The image forming method described in claim 1,
wherein the photosoftening compound is a photoisomerization compound.

3. The image forming method described in claim 1,
wherein the photosoftening compound is a compound having a bond that is cleaved by light absorption.

4. The image forming method described in claim 1,
wherein the image is an image fixed in advance.

5. The image forming method described in claim 1, further containing the step of rubbing the image after the step of irradiating the image with light to melt or to soften the image.

6. The image forming method described in claim 1, further containing the step of fixing the image in a melted state after the step of irradiating the image with light to melt or to soften the image.

7. The image forming method described in claim 6,
wherein the step of fixing the image is a light irradiation step.

8. The image forming method described in claim 1,
wherein the powder is a powder of non-spherical particles.

9. The image forming method described in claim 8,
wherein the powder is a powder of flat particles.

10. The image forming method described in claim 1,
wherein the powder has a thickness in the range of 0.2 to 3.0 μm.

11. The image forming method described in claim 1,
wherein the powder is a metal powder or a metal oxide powder.

12. The image forming method described in claim 1,
wherein the powder is a thermoresponsive material.

13. The image forming method described in claim 1,
wherein the recording medium is a resin film.

14. The image forming method described in claim 1,
wherein an amount of the light is controlled in the light irradiation step.

15. The image forming method described in claim 1,
wherein in the light irradiation step, an amount of light is controlled, and different portions on the recording medium are irradiated with light of different amounts of light so as to produce multiple portions with different adhesion states of the powder on the recording medium.

16. A printed image having an image comprising a recording medium and a layer containing a photo softening compound disposed thereon,
wherein the image has a powder.
